(19) United States
(12) Patent Application Publication
(10) Pub. No.: US 2015/0117818 A1
(43) Pub. Date: Apr. 30, 2015

(54) SPOT SIZE CONVERTER AND OPTICAL APPARATUS

(71) Applicant: FUJITSU LIMITED, Kawasaki-shi (JP)

(72) Inventors: Takeshi Matsumoto, Hadano (JP); Shigeaki Sekiguchi, Zama (JP)

(73) Assignee: FUJITSU LIMITED, Kawasaki (JP)

(21) Appl. No.: 14/488,727

(22) Filed: Sep. 17, 2014

(30) Foreign Application Priority Data
Oct. 25, 2013 (JP) 2013-221990

(51) Int. Cl. G02B 6/30

(52) U.S. Cl. CPC G02B 6/305; G02B 2006/12061
USPC 385/43

(57) ABSTRACT

A spot size converter includes a first silicon waveguide core that includes a width-fixed region having a fixed width and a width-tapered region continuing to the width-fixed region and having a width reducing toward a terminal portion, and a second waveguide core continuing to the first silicon waveguide core and covering at least the width-tapered region. The first silicon waveguide core has a thickness-wise step in the width-fixed region.

### CROSS-REFERENCE TO RELATED APPLICATION

This application is based upon and claims the benefit of priority of the prior Japanese Patent Application No. 2013-221990, filed on Oct. 25, 2013, the entire contents of which are incorporated herein by reference.

### FIELD

The embodiments discussed herein are related to a spot size converter and an optical apparatus

### BACKGROUND

In resent years, the information amount has been and is drastically increasing thanks to the spread of high-definition video distribution and so forth, and it is demanded to improve the information processing performance of a data canter and so forth. Further, it is demanded implement the improvement of the information processing performance by a device of a low cost and low power consumption, and, in recent years, a silicon photonics is investigated lively.

Since the sectional shape of a silicon waveguide core used for such a silicon photonics as just described so small as, for example, approximately 500 nm in width and approximately 220 nm in height, a mismatch with the spot size (for example, approximately several μm to 10 μm) of an optical fiber occurs. Therefore, excessively high coupling loss occurs.

Therefore, in order to suppress excessively high coupling loss, a spot size converter has been proposed in which the width of a silicon waveguide core is reduced in a tapered shape and is covered with a second core such that light transits from the silicon waveguide core to the second core to enlarge the spot size. This is referred to as second core type spot size converter.

### SUMMARY

According to an aspect of the embodiment, a spot size converter includes a first silicon waveguide core that includes a width-fixed region having a fixed width and a width-tapered region continuing to the width-fixed region and having a width reducing toward a terminal portion, and a second waveguide core continuing to the first silicon waveguide core and covering at least the width-tapered region, and the first silicon waveguide core has a thickness-wise step in the width-fixed region.

According to another aspect of the embodiment, an optical apparatus includes the spot size converter including a first silicon waveguide core that includes a width-fixed region having a fixed width and a width-tapered region continuing to the width-fixed region and having a width reducing toward a terminal portion, and a second waveguide core continuing to the first silicon waveguide core and covering at least the width-tapered region, the first silicon waveguide core having a thickness-wise steps in the width-fixed region; and a dispersion shift fiber or a single-mode fiber coupled to an end face on a side of the second waveguide core of the spot size converter.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A to 1G are schematic views depicting a configuration of a spot size, converter according to an embodiment and a particular example, wherein FIG. 1A is a top plan view; FIG. 1B is a sectional view taken along line B-B of FIG. 1A; FIG. 1C is a sectional view taken along line C-C of FIG. 1A; FIG. 1D is a sectional view taken along line D-D of FIG. 1A; FIG. 1E is a sectional view taken along line E-E of FIG. 1A; FIG. 1F is a sectional view taken along line F-F of FIG. 1A; and FIG. 1G is a sectional view taken along line G-G of FIG. 1A.

FIGS. 2A and 2B are schematic views illustrating a fabrication method for a spot size converter according to the particular example of the embodiment, wherein FIG. 2A is a top plan view and FIG. 2B is a sectional view taken along line B-B of FIG. 1A.

FIGS. 3A and 3B are schematic views illustrating the fabrication method for the spot size converter according to the particular example of the embodiment, wherein FIG. 3A is a top plan view and FIG. 3B is a sectional view taken along line B-B of FIG. 3B.

FIGS. 4A to 4C are schematic views illustrating the fabrication method for the spot size converter according to the particular example of the embodiment, wherein FIG. 4A is a top plan view; FIG. 4B is a sectional view taken along line B-B of FIG. 4A; and FIG. 4C is a sectional view taken along line C-C of FIG. 4A.

FIGS. 5A to 5C are schematic views illustrating the fabrication method for the spot size converter according to the particular example of the embodiment, wherein FIG. 5A is a top plan view; FIG. 5B is a sectional view taken along line B-B of FIG. 5A; and FIG. 5C is a sectional view taken along line C-C of FIG. 5A.

FIGS. 6A and 6B are schematic views illustrating the fabrication method for the spot size converter according to the particular example of the embodiment, wherein FIG. 6A is a top plan view and FIG. 6E is a sectional view taken along line B-B of FIG. 6A.

FIGS. 7A and 7B are schematic views illustrating the fabrication method for the spot size converter according to the particular example of the embodiment, wherein FIG. 7A is a top plan view and FIG. 7B is a sectional view taken along line B-B of FIG. 7A.

FIGS. 8A and 8B are schematic views illustrating the fabrication method for the spot, size converter according to the particular example of the embodiment, wherein FIG. 8A is a top plan view and FIG. 8B is a sectional view taken along line B-B of FIG. 9A.

FIGS. 9A and 9B are schematic views illustrating a fabrication method for the spot size converter according to the particular example of the embodiment, wherein FIG. 9A is a top plan view and FIG. 9B is a sectional view taken along line B-B of FIG. 9A.

FIGS. 10A and 10B are schematic views illustrating the fabrication method for the spot size converter according to the particular example of the embodiment, wherein FIG. 10A is a top plan view and FIG. 10B is a sectional view taken along line B-B of FIG. 10A.

FIG. 11 is a view depicting a result of calculation of the insertion loss where a dispersion shift fiber is coupled with the spot size converter according to any of the particular example of and a modification to the present embodiment.

FIG. 12 is a view depicting a result of calculation of a tip end width dependency of the insertion loss where the dispersion shift fiber is coupled with the spot size converter (where the refractive index of a second core is approximately 1.46) according to any of the particular example of and the modification to the present embodiment.

FIG. 13 is a view depicting a result of calculation of a tip end width dependency of the insertion loss where the dispersion shift fiber is coupled with the spot size converter (where the refractive index of the second core is approximately 1.48) according to any of the particular example of and the modification to the present embodiment.

FIGS. 14A to 14G are schematic views depicting a configuration of a spot size converter according to a first modification to the present embodiment, wherein FIG. 14A is a top plan view; FIG. 14B is a sectional view taken along line B-B of FIG. 14A; FIG. 14C is a sectional view taken along line C-C of FIG. 14A; FIG. 14D is a sectional view taken along line D-D of FIG. 14A; FIG. 14E is a sectional view taken along line E-E of FIG. 14A; FIG. 14F is a sectional view taken along line F-F of FIG. 14A; and FIG. 14G is a sectional view taken along line G-G of FIG. 14A.

FIGS. 15A and 15B are schematic views illustrating a fabrication method for the spot size converter according to the first modification to the embodiment, wherein FIG. 15A is a top plan view and FIG. 15B is a sectional view taken along line B-B of FIG. 15A.

FIGS. 16A and 16B are schematic views illustrating the fabrication method for the spot size converter according to the first modification to the embodiment, wherein FIG. 16A is a top plan view and FIG. 16B is a sectional view taken along line B-B of FIG. 16A.

FIGS. 17A and 17B are schematic views illustrating the fabrication method for the spot size converter according to the first modification to the embodiment, wherein FIG. 17A is a top plan view and FIG. 17B is a sectional view taken along line B-B of FIG. 17A.

FIGS. 18A and 18B are schematic views illustrating the fabrication method for the spot size converter according to the first modification to the embodiment, wherein FIG. 18A is a top plan view and FIG. 18B is a sectional view taken along line B-B of FIG. 18A.

FIG. 19 is a view depicting a result of a simulation of the loss with respect to the size of a thickness-wise step provided in a width-fixed region of a silicon waveguide core.

FIGS. 20A to 20G are schematic views depicting a configuration of a spot size converter according to a second modification to the present embodiment, wherein FIG. 20A is a top plan view; FIG. 20B is a sectional view taken along line B-B of FIG. 20A; FIG. 20C is a sectional view taken along line C-C of FIG. 20A; FIG. 20D is a sectional view taken along line D-D of FIG. 20A; FIG. 20E is a sectional view taken along line E-E of FIG. 20A; FIG. 20F is a sectional view taken along line F-F of FIG. 20A; and FIG. 20G is a sectional view taken along line G-G of FIG. 20A.

FIGS. 21A and 21B are schematic views illustrating a fabrication method for the spot size converter according to the second modification to the present embodiment, wherein FIG. 21A is a top plan view and FIG. 21B is a sectional view taken along line B-B of FIG. 21A.

FIG. 22 is a schematic top plan view depicting a configuration of a spot size converter according to a third modification to the present embodiment.

### DESCRIPTION OF EMBODIMENTS

However, in the conventional second core type spot size converter described above, the spot size cannot be increased sufficiently. For example, the spot size cannot be increased to a spot size of a dispersion shift fiber (DSF) or a single mode fiber (SMF). Therefore, low-loss coupling with a dispersion shift fiber or a single mode fiber cannot be implemented.

Therefore, it is desired to increase the spot size sufficiently and implement low-loss coupling with a dispersion, shift, fiber or a single mode fiber.

In the following, a spot size converter and an optical apparatus according to an embodiment of the present invention are described with reference to the drawings.

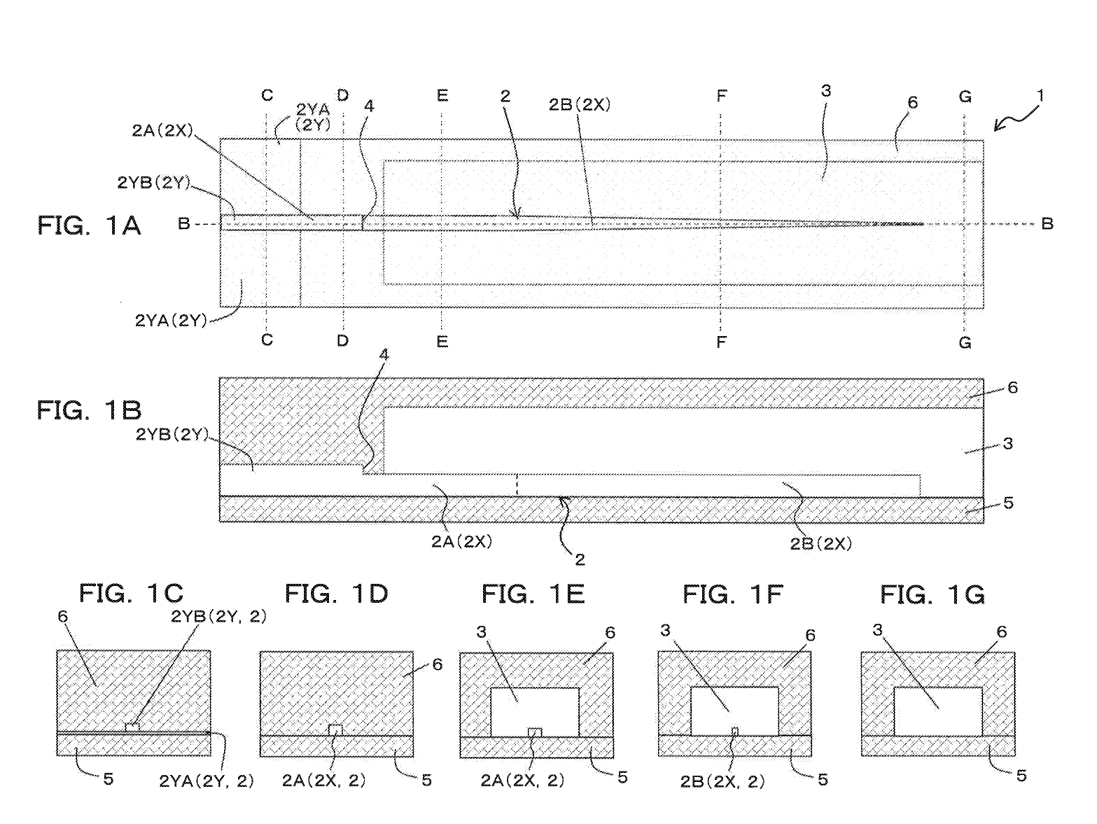

First, a spot size converter according to the present embodiment is described with reference to FIGS. 1A to 22.

The spot size converter according to the present embodiment is a second core type spot size converter in which the width of a silicon waveguide core is reduced in a tapered shape and the silicon waveguide core is covered with a second core such that light transits from the silicon waveguide core to the second core to enlarge the spot size. In such a second core type spot size converter as just described, light gradually transits from the silicon waveguide core to the second core in the region in which the width of the silicon waveguide core is reduced in a tapered shape and finally the light completely transits to the second core to enlarge the spot size. Such a spot size converter as just described is provided, for example, in a silicon optical device formed on a silicon substrate.

It is to be noted that the spot size is referred to also as spot diameter, mode field size, mode size, mode field diameter or mode diameter. Further, the silicon optical device is referred to also as optical semiconductor device. Further, the spot size converter is referred to also as optical spot size converter.

In the present embodiment, the spot size converter 1 includes a silicon waveguide core 2 (first silicon waveguide core) and a second core 3 (second waveguide core) as depicted in FIGS. 1A to 1G.

Here, the silicon waveguide core 2 includes a width-fixed region 2A having a fixed width and a width-tapered region 23 continuing to the width-fixed region 2A and having a width reducing toward a terminal end portion (tip end portion). Here, the width-tapered region 233 is a width-tapered region whose width reduces toward an enlarging direction of the spot size. Further, the width-tapered region 2B is a region having a width-tapered structure. Further, the width-tapered region 2B has a fixed thickness.

The second core 3 continues to the silicon waveguide core 2 and at least covers the width-tapered region 2B. Here, the second core 3 covers not only the width-tapered region 2B but also the width-fixed region 2A partially. Further, the second core 3 has a cross-sectional size fixed along the overall length thereof.

The silicon waveguide core 2 has a step 4 in the thickness-wise direction, in the width-fixed region 2A. In particular, the step 4 is provided in a region, which is not covered with the second core 3, of the width-fixed region 2A of the silicon waveguide core 2

The reason why the spot size converter 1 of the present embodiment is configured in such a manner as described above is such as follows.

First, as described above, a conventional second core type spot size converter fails to sufficiently enlarge the spot size. For example, although the spot size can be enlarged to the spot size of a small-diameter core fiber (for example, to approximately 4 μm), the spot size cannot be enlarged to the spot size of a dispersion shift fiber (for example, to approximately 8 μm) or to the spot size of a single mode fiber (for example, to approximately 10.5 μm). Therefore, although low-loss coupling with the small diameter core fiber can be implemented, low-loss coupling with the dispersion shift fiber or the single mode fiber has not been able to be implemented as yet. It is to be noted that, if the spot size can be sufficiently enlarged and low-loss coupling with the dispersion shift fiber or the single mode fiber can be implemented by the spot size converter, then a dispersion shift fiber or a single mode fiber that are less expensive than a small diameter core fiber can be used and reduction of the cost can be implemented.

In this case, in order to implement low-loss coupling with the dispersion shift fiber or the single mode fiber, for example, it seems promising to increase the size of the second core and reduce the refractive index of the second core to enlarge the spot size.

However, if the size of the second core is increased simply and the refractive index of the second core is reduced simply in order to enlarge the spot size, then the loss when light transits from the silicon waveguide core to the second core increases. Therefore, it is difficult to implement low-loss coupling with the dispersion shift fiber or the single mode fiber.

Increase of the loss when light transits from the silicon waveguide core to the second core where the size of the second core is increased and the refractive index of the second core is decreased in this manner arises from the fact that, the loss of a TM polarization component increases. In this case s also the polarization dependency increases. In particular, where the size of the second core is increased and the refractive index of the second core is decreased, the loss of the TM polarization component increases remarkably arid the polarization dependency increases. In this manner, that the loss of the TM polarization component increases remarkably arises from the fact that the TM polarization component is less likely to transit to the second core because the thickness (film thickness) of the silicon waveguide core is fixed.

In this case, in order to promote the transition of the TM polarization component to the second core, it seems promising to reduce also the thickness of the silicon waveguide core in a tapered shape similarly to reduction of the width of the silicon waveguide core in a tapered shape, to reduce the width of a terminal end portion of the silicon waveguide core, namely, of the tip end portion of the width-tapered region, as far as possible, or to use a combination of the countermeasures just described.

However, the reduction of the thickness of the silicon waveguide core in a tapered shape is high in difficulty in the process. Further, even if it is tried to reduce the width of the tip end portion of the width-tapered region of the silicon waveguide core as far as possible, there is a limitation to such reduction and besides it is difficult to produce the silicon waveguide core of the configuration just described with a high degree of high accuracy.

Thus, it seems promising to reduce the width of the silicon waveguide core in a tapered shape and reduce the thickness in a stepped shape in a region in which the width is reduced in a tapered shape so that the silicon waveguide core can be easily produced.

However, it has been found that a step in a thickness-wise direction appears in a region in which light transits from the silicon waveguide core to the second core and the transition of light occurs drastically at the step, resulting in increase of the loss. In particular, it has been found that, even if the thickness is reduced in a stepped shape in the region in which the width of the silicon waveguide core is reduced in a tapered shape, the loss of the TM polarization component cannot be suppressed and it is difficult to implement a low polarization dependency. In this manner, it has been found that, even, if the thickness is reduced in a stepped shape in the region in which the width of the silicon waveguide core is reduced in a tapered shape, the loss when light transits from the silicon waveguide core to the second core cannot be suppressed and it is difficult to implement low-loss coupling with the dispersion shift fiber or the single mode fiber.

Therefore, in the present embodiment, the step 4 in the thickness-wise direction is provided in a region of the silicon waveguide core 2 other than the width-tapered region 2B, namely, in the width-fixed region 2A as described above. In particular, by reducing the thickness in a stepped shape in the width-fixed region 2A continuing to the width-tapered region 2B of the silicon waveguide core 2, the thickness of the width-tapered region 2B is reduced and the thickness of the tip end portion of the width-tapered region 2B is reduced.

By providing the step 4 in the thickness-wise direction in a region in which light does not transit between the silicon waveguide core 2 and the second core 3 or in a region in which the transition amount of light is small in this manner, sudden transition of light at the stepped location can be avoided and increase of the loss can be suppressed. Consequently, the second core type spot size converter 1 with low loss can be implemented. In other words, in the second core type spot size converter 1, the loss of the TM polarization component can be suppressed and low-polarization dependency can be implemented. Therefore, where the size of the second core 3 is increased and the refractive index of the second core 3 is decreased in order to enlarge the spot size to a size capable of achieving high-efficiency coupling with a dispersion shift fiber or a single mode fiber which are less expensive, the loss when light transits from the silicon waveguide core 2 to the second core 3 can be suppressed low. As a result, low-loss coupling with a dispersion shift fiber or a single mode fiber can be implemented and reduction of the cost can be implemented.

In the following, description is given in connection with a particular example.

As depicted in FIGS. 1A to 1G, the spot size converter 1 includes a SiO₂ lower cladding layer 5 provided on a silicon substrate not depicted, the silicon waveguide core 2 provided on the SiO₂ lower cladding layer 5, the second core 3 partially covering the silicon waveguide core 2 and a SiO₂ upper cladding layer 6 covering the silicon waveguide core 2 and the second core 3.

The silicon waveguide core 2 includes a channel structure portion 2X [for example, refer to FIGS. 1D to 1F] and a rib structure portion 2Y [for example, refer to FIG. 1C] continuing to the channel structure portion 2X, Here, the channel structure portion 2X is a channel-shaped portion having a square cross sectional shape, and the rib structure portion 2Y has a slab portion 2YA and a rib portion 2YB. It is to be noted that the channel structure portion 2X is referred to also as channel structure silicon waveguide core or channel waveguide core. Further, the rib structure portion 2Y is referred to also as a rib structure silicon waveguide core or rib waveguide core. Further, the rib structure portion 2Y is a coupling portion with a different optical device (optical functional device). The channel structure portion 2X of the silicon waveguide core 2 includes the width-fixed region 2A having no width variation and the width-tapered region 2B, and has the step 4 in the thickness-wise direction (film thickness-wise direction) in the width-fixed region 2A. Here, the rib structure portion 2Y of the silicon waveguide core 2 continues to the opposite side to the width-tapered region 2B across the width-fixed region 2A. It is to be noted that the silicon waveguide core 2 may be configured not including the rib structure portion 2Y but including only the channel structure portion 2X.

Here, the second core 3 not only covers the width-tapered region 2B but also covers the width-fixed region 2A partially and continues to the silicon waveguide core 2. The step 4 is provided in the region, which is not covered with the second core 3, of the width-fixed region 2A of the silicon waveguide core 2.

Here, the thickness of the SiO₂ lower cladding layer 5 is, for example, approximately 3 μm, and the refractive index of the SiO₂ lower cladding layer 5 is approximately 1.44.

The width of the silicon waveguide core 2 is, for example, approximately 500 nm at the width-fixed region 2A of the channel structure portion 2X and reduces, in the width-tapered region 2B, in a tapered shape toward the tip end portion, for example, from approximately 500 ran to approximately 50 nm, and configures a single mode waveguide. Further, the thickness of the silicon waveguide core 2 is, for example, approximately 220 nm to the step formation location of the width-fixed region 2A of the channel structure portion 2X, and a step of, for example, approximately 30 nm is provided at one location and the thickness is, for example, approximately 190 nm from the step formation location to the tip end portion of the width-tapered region 2B. Further, in the silicon waveguide core 2, the thickness of the slab portion 2YA of the rib structure portion 2Y is, for example, approximately 50 nm and the thickness of the rib portion 2YB is, for example, approximately 220 nm, and the width of the rib portion 2YB is, for example, approximately 500 nm. It is to be noted that the refractive index of the silicon waveguide core 2 is approximately 3.48.

The second core 3 is a SiO_{X} waveguide core (silicon compound waveguide core) for which SiO_{X} (silicon oxide; silicon compound) is used as a material, and has, for example, a thickness of approximately 3 μm, a width of approximately 7 μm and a refractive index of approximately 1.46. In this manner, the second core 3 has a refractive index lower than that of the silicon waveguide core 2 and has a cross-sectional size greater than that of the silicon waveguide core 2, and configures a single mode waveguide.

The thickness of the SiO₂ upper cladding layer 6 is, for example, approximately 1 μm over the second core 3 but is, for example, approximately 2 μm. at a portion other than the portion over the second core 3, and has a refractive index of approximately 1.44.

In the particular example, in order to increase the size of the second core 3 so as to satisfy a single mode condition, the thickness (height) and the width of the second core 3 are set to approximately 3 μm and approximately 7 μm, respectively. Further, in order to decrease the refractive, index of the second core 3, the refractive index of the second core 3 is set to approximately 1.46. Consequently, the spot size is enlarged to a size capable of achieving high-efficiency coupling with a dispersion shift fiber or a single mode fiber. Further, the step 4 of approximately 30 nm is provided at one location of the width-fixed region 2A of the silicon waveguide core 2 and the thickness of the width-tapered region 2B of the silicon waveguide core 2 is set to approximately 190 nm so that the loss when light transits from the silicon waveguide core 2 to the second core 3 is suppressed low and low-loss coupling with a dispersion shift fiber or a single mode fiber is implemented. Further, since the spot, size is enlarged by uniformly increasing the cross-sectional size of the second core 3 over the overall length, it is possible to achieve compaction in comparison with an alternative case in which the spot size is enlarged by increasing the length of the second core and increasing the cross-sectional size in a stepped shape or a tapered shape.

For example, the insertion loss of a dispersion shift fiber where a step is provided in the width-tapered region 2B of the silicon waveguide core 2 is approximately 1.8 dB in regard to a TM polarization component and approximately 1.1 dB in regard to a TE polarization component. In contrast, the insertion loss for a dispersion shift fiber where the step 4 is provided in the width-fixed region 2A of the silicon waveguide core 2 as described above is approximately 1.5 dB in regard to a TM polarization component and approximately 1.1 dB in regard to a TE polarization component. In this manner, in regard to the TM polarization component, reduction of loss by approximately 20 percent was implemented successfully.

The spot size converter having such a configuration, of the particular example as described above can be produced, for example, in such a manner as described below using, for example, a SOI (silicon on insulator) substrate. It is to be noted that the SOI substrate is referred to also as SOI wafer substrate.

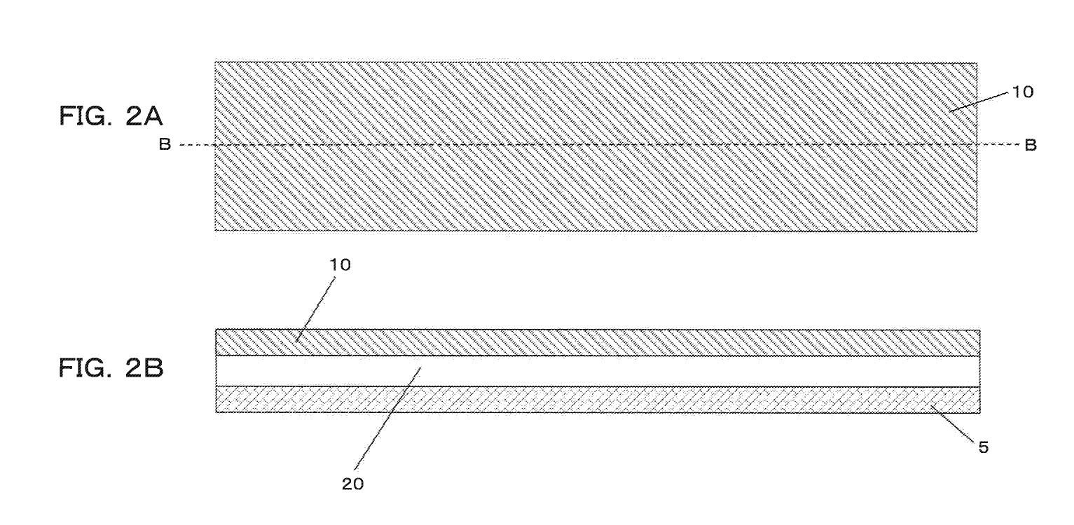

First, a SiO₂ film 10 (for example, approximately 50 nm thick) is deposited by a CVD method as depicted in FIGS. 2A and 2B on a SOI substrate (the thickness of a BOX layer that is a SiO₂ layer is approximately 3 μm and the thickness of a SOI layer 20 that is a silicon layer is approximately 220 nm). Here, SiH₄ (20%)/He and N₂O may be used as raw material gas. It is to be noted that the BOX layer functions as the SiO₂ lower cladding layer 5.

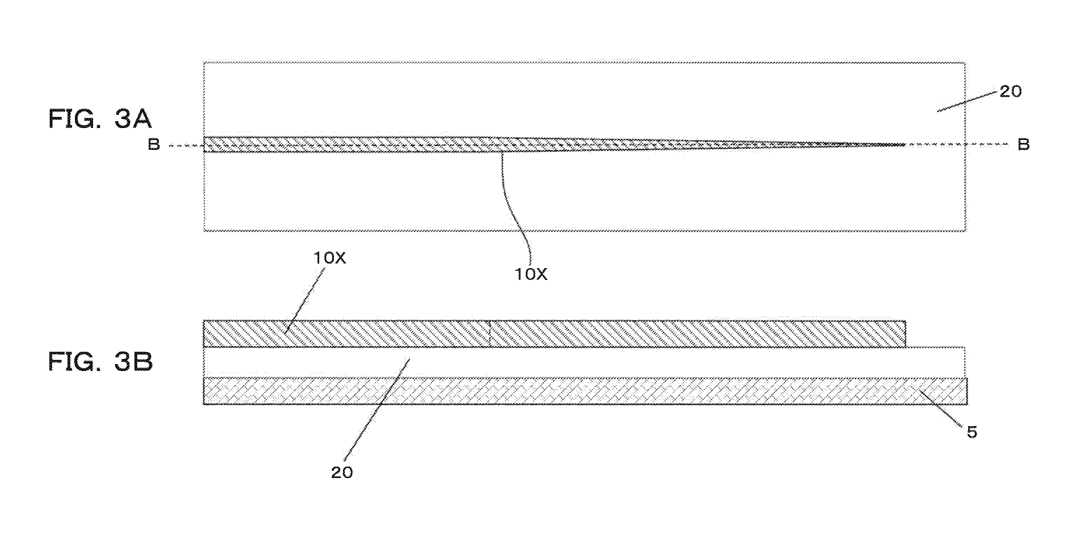

Then, a photoresist pattern is formed on the SiO₂ film 10 and the SiO₂ film 10 is etched by RIE using CF₄ gas so that a hard mask pattern 10X is formed as depicted in FIGS. 3A and 3B. Here, the hard mask pattern 10X is a pattern for processing the SOI layer 20 to form the silicon waveguide core 2.

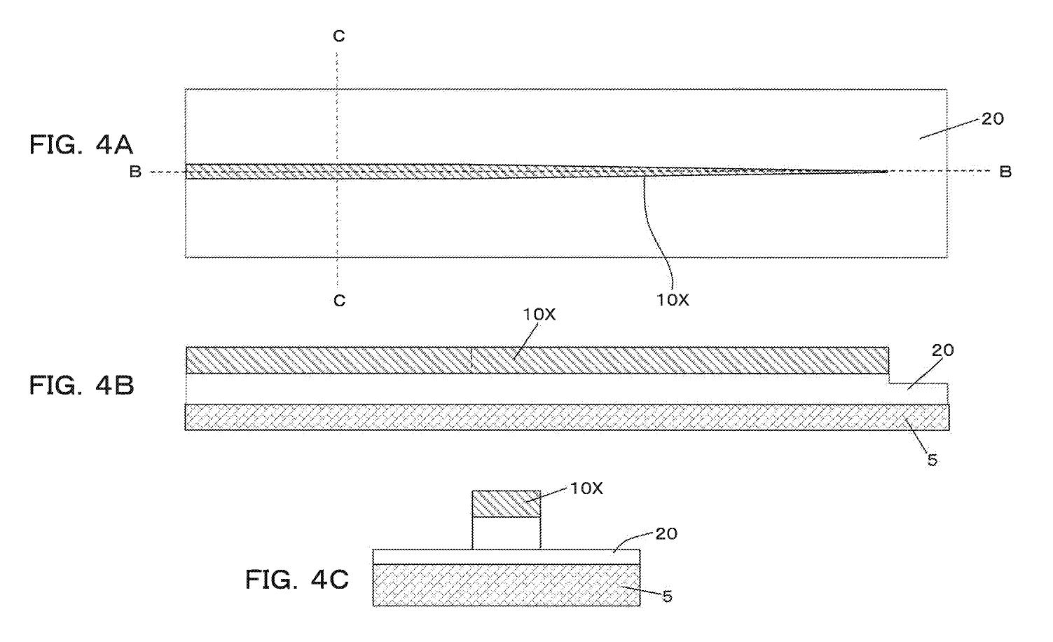

Then, the photoresist, pattern is removed, and then the SOI layer 20 that is a silicon layer is etched by RIE using HBr gas as depicted in FIGS. 4A to 4C. Here, the etching amount is controlled so that the SOI layer 20 that is a silicon layer remains by approximately 50 nm at both sides of a portion formed as the channel structure portion 2X and the rib portion 2YB of the rib structure portion 2Y of the silicon waveguide core 2. Consequently, the slab portion 2YA and the rib portion 2YB of the rib structure portion 2Y of the silicon waveguide core 2 are formed.

It is to be noted that the rib structure portion 2Y of the silicon waveguide core 2 is coupled to a different optical device and also the different optical device has a rib structure portion of a silicon waveguide core. Where a current injection region or the like is to be provided at the rib structure portion, ion injection may be selectively performed at this stage to form a p-type doped region and an n-type doped region to form a p-i-n structure.

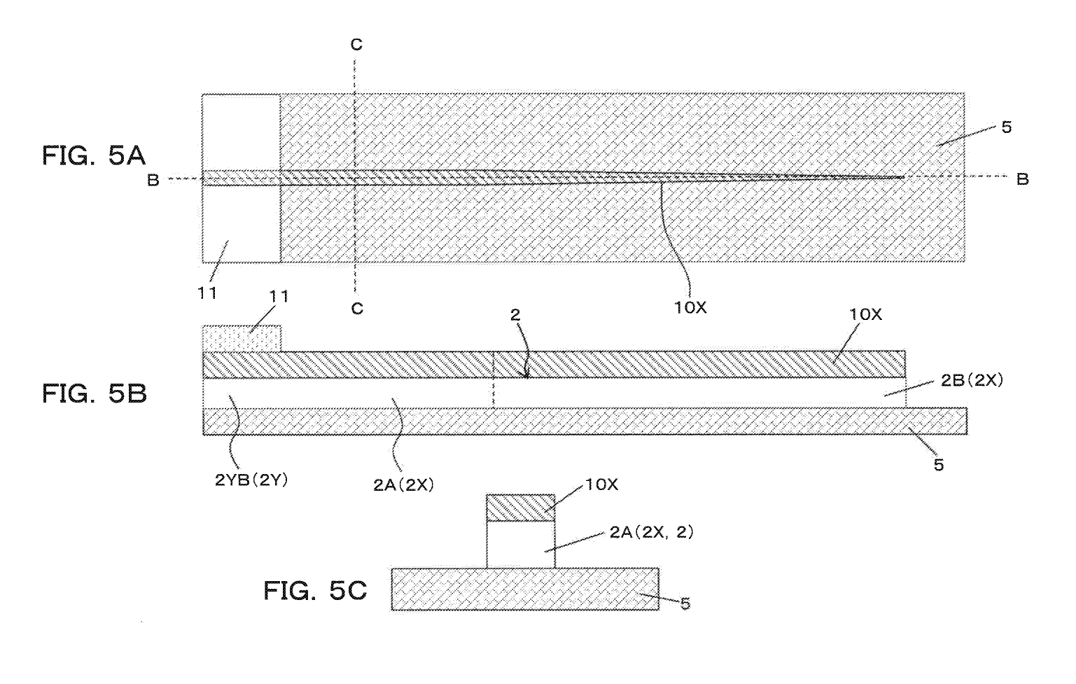

Then, the SOI layer 20 that is the silicon layer remaining by approximately 50 nm in a region (channel waveguide region) other than the region (rib waveguide region), in which the rib structure portion 2Y of the silicon waveguide core 2 is to be formed, is removed using the hard mask pattern 10X and a resist pattern 11 that covers the rib structure portion 2Y of the silicon waveguide core 2 as depicted in FIGS. 5A to 5C. Consequently, the width-fixed region 2A and the width-tapered region 2B of the channel structure portion 2X of the silicon waveguide core 2 are formed.

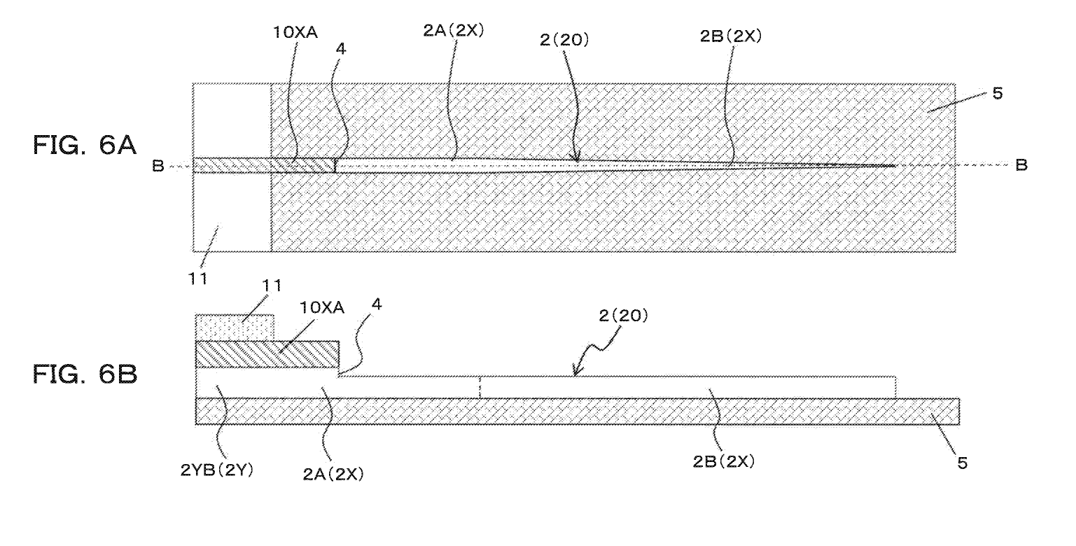

Then, the SOI layer 20 from an arbitrary location of the width-fixed region 2A to a tip end portion of the width-tapered region 2B of the channel structure portion 2X of the silicon waveguide core 2 is etched by approximately 30 nm using a hard mask pattern 10XA that remains from the rib structure portion 2Y of the silicon waveguide core 2 to a location at which the step 4 is to be formed, and the resist pattern 11 that covers the rib structure portion 2Y of the silicon waveguide core 2 as depicted in FIGS. 6A and 6B. Consequently, the step 4 of approximately 30 nm in the thickness-wise direction is provided in the width-fixed region 2A of the silicon waveguide core 2 and the width-tapered region 2B has a thickness of approximately 190 nm.

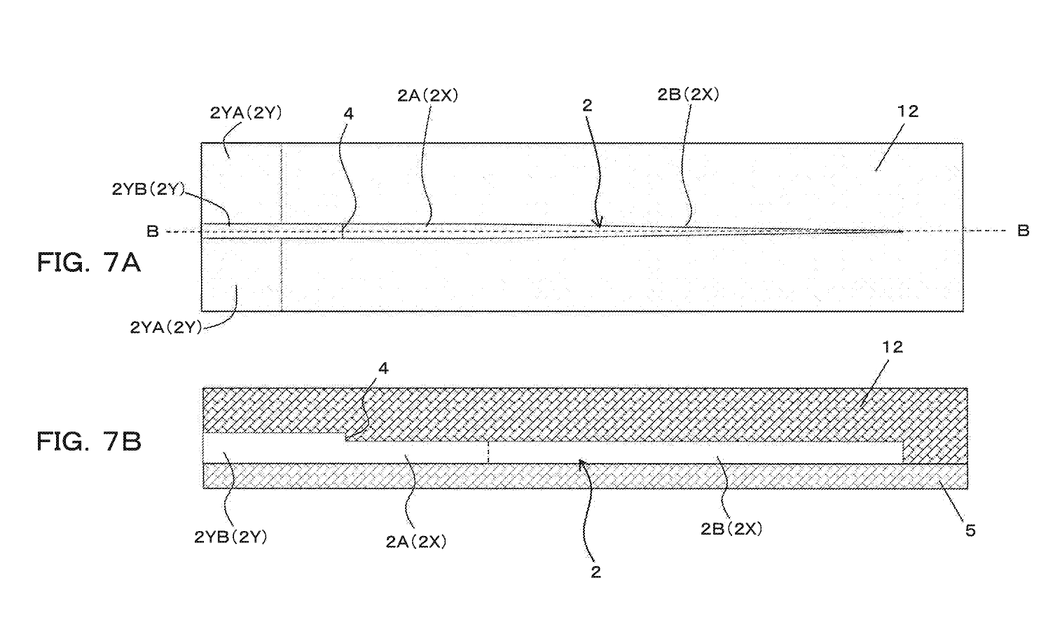

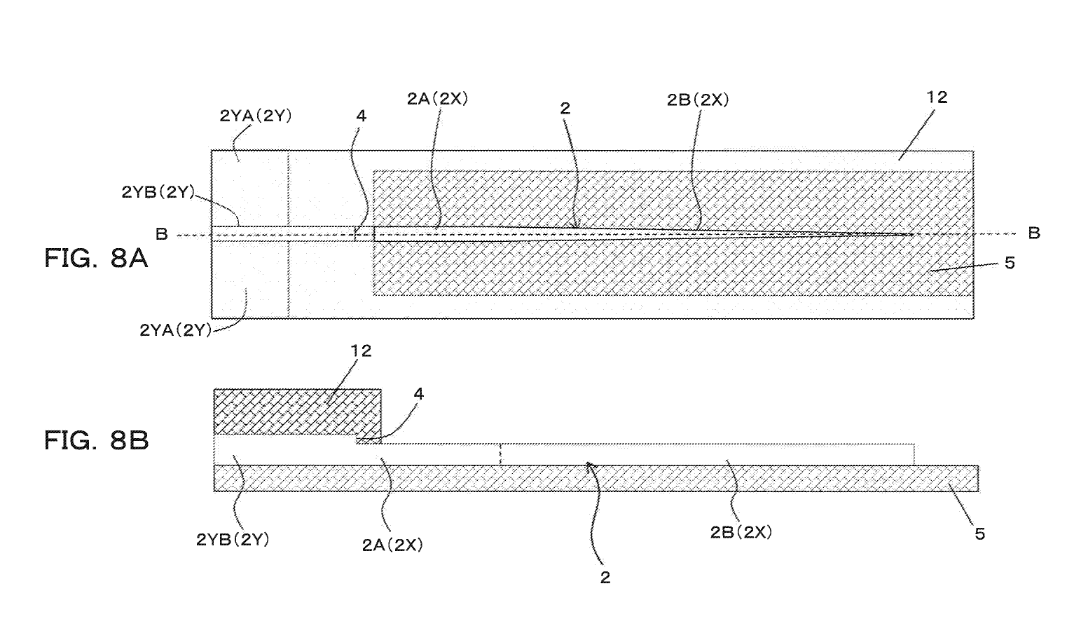

Then, the hard mask pattern 10XA and the resist pattern 11 are removed, and then a SiO₂ film 12 (for example, approximately 1 μm thick) is deposited by a CVD method as depicted in FIGS. 7A and 7B and the SiO₂ film 12 in a region in which the second core 3 is to be formed is removed by etching as depicted in FIGS. 8A and 8B.

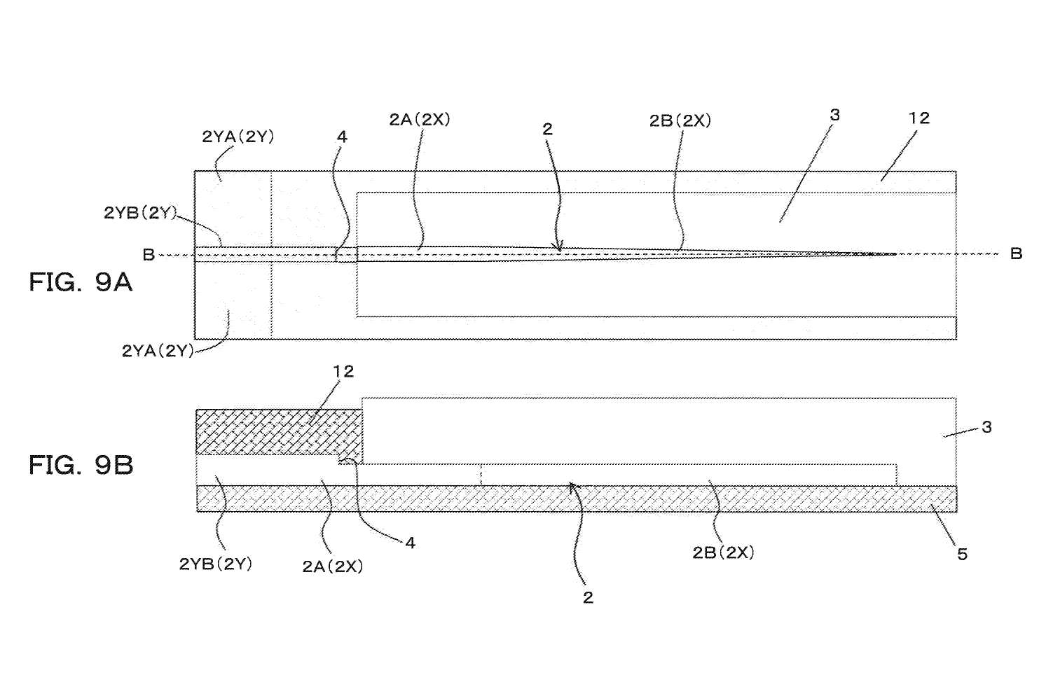

Then, a SiO_{X} film (for example, of a thickness of approximately 3 μm, a width of approximately 7 μm, a refractive index n=1.46) is deposited as depicted in FIGS. 9A and 9B by a CVD method. Then, the unnecessary SiO_{X} film is removed by etching to form the second core 3 such that the second core 3 covers the width-tapered region 2B and part, of the width-fixed region 2A of the silicon waveguide core 2.

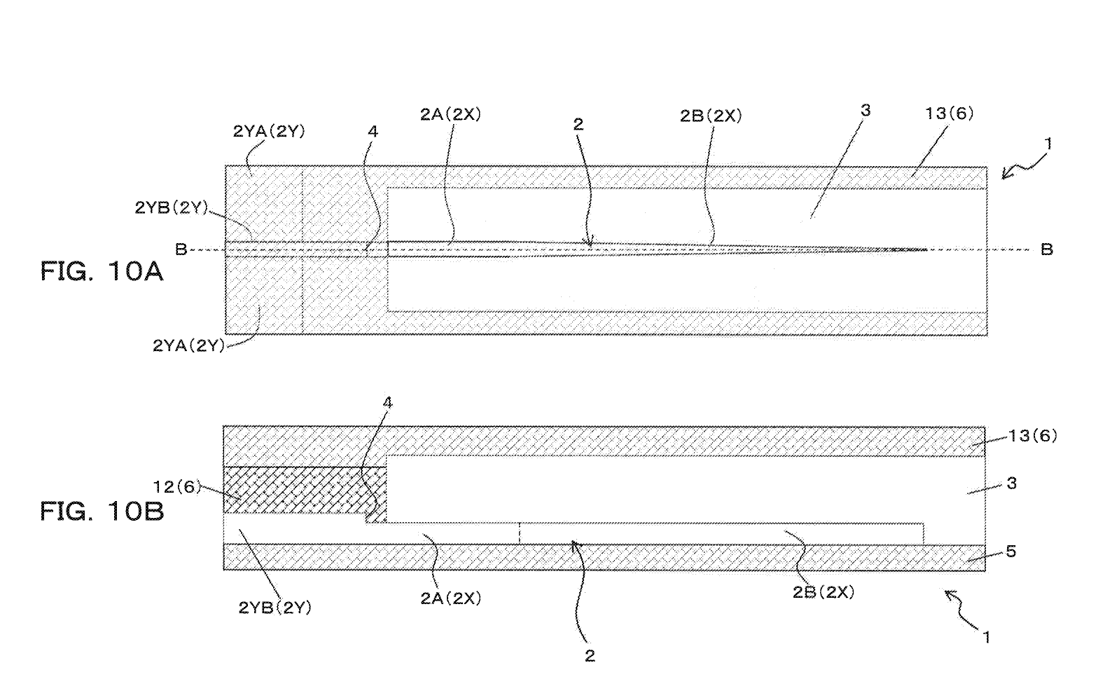

Then, a SiO₂ film 13 (for example, approximately 1 μm thick) is deposited by a CVD method so as to cover the silicon waveguide core 2 and the second core 3 as depicted in FIGS. 10A and 10B to form the SiO₂ upper cladding layer 6 including the SiO₂ film 12 and the SiO₂ film 13. Consequently, the spot size converter 1 having the configuration of the particular example described above is produced.

It is to be noted that, where a current injection region is to be provided in a different optical device coupled to the spot size converter 1, the SiO₂ films 12 and 13 deposited, on the p-type doped region and the n-type doped region may be removed by etching to form a contact hole, in which an electrode is formed.

Accordingly, with the spot size converter 1 according to the present embodiment, there is an advantage that the spot size can be sufficiently enlarged and low-loss coupling with a dispersion shift, fiber or a single mode fiber can be implemented.

It is to be noted that the present invention is not limited to the configuration of the embodiment specifically described above, and variations and modifications can be made without departing from the scope of the present invention.

For example, while the refractive index of the second core 3, namely, the refractive index of the material of the second core 3, in the particular example of the embodiment described above is approximately 1.46, the refractive index of the second, core 3 is not limited to this. In particular, in order to implement low-loss coupling with a dispersion shift fiber or a single mode fiber, the refractive index of the second core 3 may be equal to or higher than, approximately 1.45 but equal to or lower than approximately 1.48. Preferably, the refractive index of the second core 3 is equal to or higher than approximately 1.46 but equal to or lower than 1.48. More preferably, the refractive index of the second, core 3 is equal to or higher than approximately 1.46 but equal to or lower than 1.47. It is to be noted that, as the refractive Index of the second core 3 increases, the spot size decreases and coupling loss with a dispersion shift fiber or a single dispersion fiber increases. However, the condition for the width (tip end width) of the tip end portion of the width-tapered region 2B of the silicon waveguide core 2 is moderated, namely, the range of the tip end width capable of implementing a low polarization dependency increases, and increase of the polarization dependency can be suppressed easily.

Further, in the particular example of the embodiment described above, where the refractive index of the second core 3 is approximately 1.46, the step 4 of approximately 30 nm is provided in the width-fixed region 2A of the silicon waveguide core 2 and the thickness of the width-tapered region 2B of the silicon waveguide core 2 (particularly, the thickness at the tip end portion of the width-tapered region 2B) is approximately 190 nm. However, the dimensions of them are not limited to them.

For example, where the refractive index of the second core 3 is approximately 1.45 to 1.48, even if the step 4 of approximately 30 nm is provided in the width-fixed region 2A of the silicon waveguide core 2 and the thickness of the width-tapered region 2B of the silicon waveguide core 2 (particularly, the thickness of the tip end portion of the width-tapered region 23) is approximately 190 nm, the loss when light transits from the silicon waveguide core 2 to the second core 3 can be suppressed low and low-loss coupling with a dispersion shift fiber and a single mode fiber can be implemented. Further, where the refractive index of the second core 3 is approximately 1.45 to 1.48, even if the step 4 of approximately 20 nm is provided in the width-fixed region 2A of the silicon waveguide core 2 and the thickness of the width-tapered region 2B of the silicon waveguide core 2 (particularly, the thickness of the tip end portion of the width-tapered region 2B) is approximately 200 nm, the loss when light transits from the silicon waveguide core 2 to the second core 3 can be suppressed low and low-loss coupling with a dispersion shift fiber and a single mode fiber can be implemented. Further, where the refractive index of the second core 3 is approximately 1.45 to 1.48,even if the step 4 of approximately 50 nm is provided in the width-fixed region 2A of the silicon waveguide core 2 and the thickness of the width-tapered region 2B of the silicon waveguide core 2 (particularly, the thickness of the tip end portion of the width-tapered region 2B) is approximately 170 nm, the loss when light transits from the silicon waveguide core 2 to the second core 3 can be suppressed low and low-loss coupling with a dispersion shift fiber and a single mode fiber can be implemented.

In this manner, where the refractive index of the second core 3 is approximately 1.45 to 1.48, if the step 4 of approximately 20 nm to 50 nm (namely, approximately 20 nm or more) is provided in the width-fixed region 2A of the silicon waveguide core 2 and the thickness of the width-tapered region 2B of the silicon waveguide core 2 (particularly, the thickness of the tip end portion of the width-tapered region 2B) is approximately 200 nm to 170 nm (namely, approximately 200 nm or less), then the loss when light transits from the silicon waveguide core 2 to the second core 3 can be suppressed low and low-loss coupling with a dispersion shift fiber and a single mode fiber can be implemented,

It is to be noted here that, while the embodiment is described taking, as an example, the case in which the step 4 of approximately 20 nm to 50 nm is provided and the thickness of the width-tapered region 2B of the silicon waveguide core 2 (particularly, the thickness of tip end portion of the width-tapered region 2B) is approximately 200 nm to 170 nm as an example, the step 4 having a size outside the range from approximately 20 nm to 50 nm may be provided and the width-tapered region 2B of the silicon waveguide core 2 may have a thickness outside the range from approximately 200 nm to 170 nm.

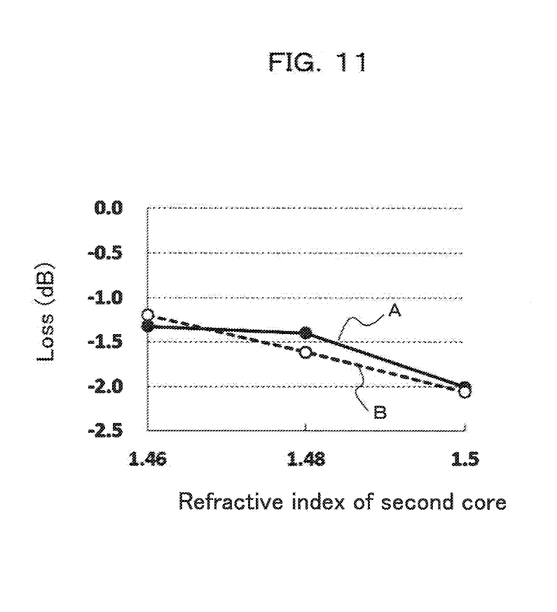

Here, FIG. 11 depicts a result of calculation of the insertion loss (coupling loss) where a dispersion shift fiber is coupled with the spot size converter 1 in which the refractive index of the second core 3 is set low and the step 4 is provided in the width-fixed region 2A of the silicon waveguide core 2.

It is to be noted that, in FIG. 11, there are plotted calculation values where the refractive index of the second core 3 is approximately 1.48 and the step 4 of approximately 20 nm is provided in the width-fixed region 2A of the silicon waveguide core 2 and besides the thickness of the width-tapered region 2B of the silicon waveguide core 2 (particularly, the thickness of the tip end portion of the width-tapered region 2B) is approximately 200 nm, calculation values where the refractive index of the second core 3 is approximately 1.46 and the step 4 of approximately 50 nm is provided in the width-fixed region 2A of the silicon waveguide core 2 and besides the thickness of the width-tapered region 23 of the silicon waveguide core 2 (particularly, the thickness of the tip end portion of the width-tapered region 2B) is approximately 170 nm, and calculation values where the refractive index of the second core 3 is approximately 1.50 and the step is not provided in the width-fixed region 2A of the silicon waveguide core 2 and besides the thickness of the width-tapered region 2B of the silicon waveguide core 2 (particularly, the thickness of the tip end portion of the width-tapered region 2B) is approximately 220 nm. Here, in any case, the width (tip end width) of the tip end portion of the width-tapered region 2B of the silicon waveguide core 2 is approximately 50 nm. Further, in FIG. 11, a solid line A and a solid line B indicate a calculation value of a TE polarization component and a calculation value of a TM polarization component, respectively.

As depicted in FIG. 11, in comparison with a case in which the refractive index of the second core 3 is approximately 1.50 and the step 4 is not provided in the width-fixed region 2A of the silicon waveguide core 2, in a case in which the refractive index of the second core 3 is set to approximately 1.48 and the step 4 is provided in the width-fixed region 2A of the silicon waveguide core 2 and another case in which the refractive index of the second core 3 is approximately 1.46 and the step 4 is provided in the width-fixed region 2A of the silicon waveguide core 2, low-loss coupling with a dispersion shift fiber can be implemented. In this manner, even if the refractive index of the second core 3 is set low in order to increase the spot, size, by providing the step 4 in the width-fixed region 2A of the silicon waveguide core 2, low-loss coupling with a dispersion shift fiber can be implemented with the producible tip end width of approximately 50 nm while a low polarization dependency is maintained.

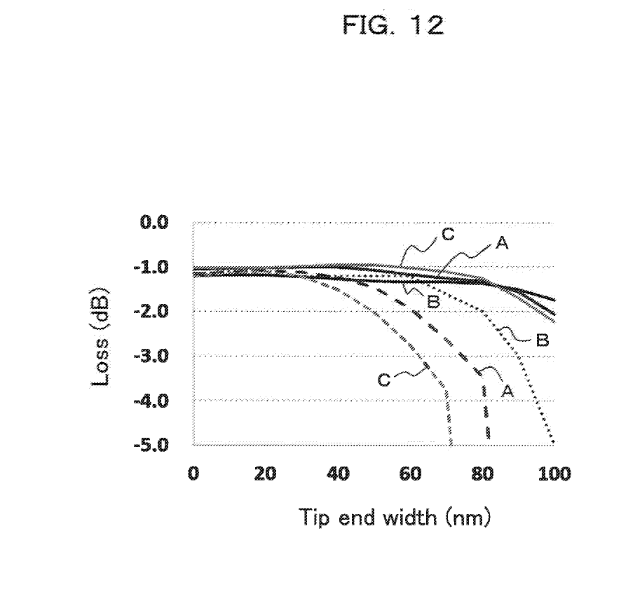

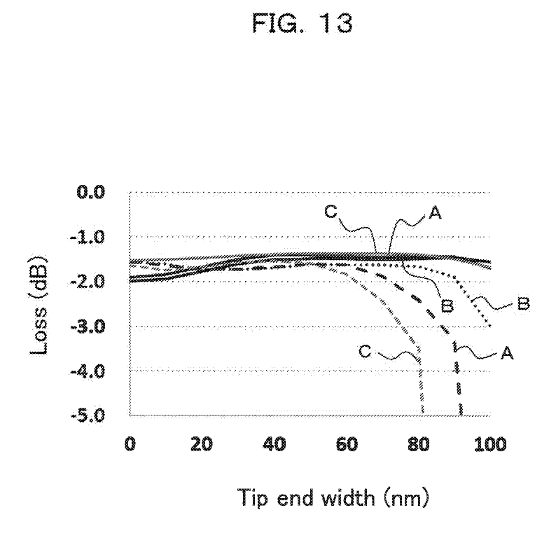

Here, FIGS. 12 and 13 depict results of calculation of the tip end width dependency of the insertion loss (coupling loss) with a dispersion shift fiber. It is to be noted that. FIG. 12 depicts a result of the calculation where the refractive index of the second core 3 is approximately 1.46 and FIG. 13 depicts a result of the calculation where the refractive index of the second core 3 is approximately 1.48. Further, in FIGS. 12 and 13, solid lines A to C indicate values with regard to the TE polarization component and broken lines A to C indicate values with regard to the TM polarization component. Further, in FIGS. 12 and 13, the solid line A and the broken line A indicate the values where the thickness of the width-tapered region 2B of the silicon waveguide core 2 (particularly, the thickness of the tip end portion of the width-tapered region 2B) is approximately 200 nm, namely, where the step 4 of approximately 20 nm is provided in the width-fixed region 2A of the silicon waveguide core 2. Further, in FIGS. 12 and 13, the solid line B and the broken line B indicate the values where the thickness of the width-tapered region 2B of the silicon waveguide core 2 (particularly, the thickness of the tip end portion of the width-tapered region 2B) is approximately 170 nm, namely, where the step 4 of approximately 50 nm is provided in the width-fixed region 2A of the silicon waveguide core 2. Further, for comparison, in FIGS. 12 and 13, the values in a case in which the thickness of the width-tapered region 2B of the silicon waveguide core 2 (particularly, the thickness of the tip end port ion of the width-tapered region 2B) is approximately 220 nm, namely, the value in a case in which the step is not provided, are indicated by the solid line C and the broken line C.

First, as depicted in FIGS. 12 and 13, in comparison with the case in which the step is not provided, in both of the case in which the refractive index of the second core 3 is approximately 1.46 and the case in which the refractive index of the second core 3 is approximately 1.48, by providing the step 4 in the width-fixed region 2A of the silicon waveguide core 2, the loss of the TM polarization component can be suppressed and increase of the polarization dependency can be suppressed.

Further, as depicted in FIGS. 12 and 13, in comparison with the case in which the step is not. provided, in both of the case in which the refractive index of the second core 3 is approximately 1.46 and the case in which the refractive index of the second core 3 is approximately 1.48, by providing the step 4 in the width-fixed region 2A of the silicon waveguide core 2, the tip end width of the width-tapered region 2B of the silicon waveguide core 2 need not be reduced anymore in order to suppress increase of the polarization dependency. Consequently, the fabrication of the spot size converter can be facilitated and the spot size converter can be produced with high accuracy.

Further, as depicted in FIGS. 12 and 13, where the refractive index of the second core 3 is approximately 1.48, since the spot size is decreased in comparison with that, for example, in an alternative case in which the refractive index is set to approximately 1.46, the coupling loss with a dispersion shift fiber increases. On the other hand, since the condition for the tip end width of the width-tapered region 2B of the silicon waveguide core 2 is moderated, namely, since the range of the tip end width capable of implementing a low polarization dependency increases, increase of the polarization dependency can be suppressed easily.

Further, where the refractive index of the second core 3 is approximately 1.46 and the step is not provided, namely, where the thickness of the width-tapered region 2B of the silicon waveguide core 2 is approximately 220 nm, in order to suppress the loss of the TM polarization component and increase of the polarization dependency, preferably the tip end width of the width-tapered region 2B is reduced to approximately 30 nm or less as indicated by a solid line C and a broken line C in FIG. 12, which is difficult to achieve in fabrication.

On the other hand, where the refractive index of the second core 3 is approximately 1.46 and the step 4 of approximately 20 nm is provided in the width-fixed region 2A of the silicon waveguide core 2, namely, where the thickness of the width-tapered region 2B of the silicon waveguide core 2 is approximately 200 nm, as indicated by the solid line A and the broken line A in FIG. 12, even if the tip end width of the width-tapered region 2B is set to approximately 40 nm, the loss of the TM polarization component and increase of the polarization dependency can be suppressed. In this manner, where the step 4 is small and the thickness of the width-tapered region 2B of the silicon waveguide core 2 is made not very thin, by reducing the tip end width of the width-tapered region 23, for example, by setting the tip end width of the width-tapered region 2B to approximately 50 nm or less (preferably, to approximately 40 nm or less), the loss of the TM polarization component and increase of the polarization dependency can be suppressed.

Further, -where the refractive index of the second core 3 is approximately 1.46 and the step 4 of approximately 50 nm is provided in the width-fixed region 2A of the silicon waveguide core 2, namely, where the thickness of the width-tapered, region 2B of the silicon waveguide core 2 is approximately 170 nm, even if the tip end width of the width-tape red region 2B is set to approximately 70 nm as indicated by a solid line B and a broken line B in FIG. 12, the loss of the TM polarization component and increase of the polarization dependency can be suppressed. In this manner, where the step 4 is great and the thickness of the width-tapered region 23 of the silicon waveguide core 2 is reduced, even if the tip end width of the width-tapered region 2B is great, if the tip end width of the width-tapered region 2B is set, for example, to approximately 70 nm or less, then the loss of the TM polarization component and increase of the polarization dependency can be suppressed.

In this manner, even if the refractive index of the second core 3 is decreased to approximately 1.46 in order to increase the spot size and implement low-loss coupling with a dispersion shift fiber, by providing the step 4 in the width-fixed region 2A of the silicon waveguide core 2, the loss of the TM polarization component can be suppressed and low polarization dependency can be implemented with a producible tip end width.

It is to be noted here that, while the tip end width described above can be produced also where the tip end. width of the width-tapered region 2B of the silicon waveguide core 2 is approximately 40 nm, also there is a case in which, even if the tip end width of the width-tapered region 2B of the silicon waveguide core 2 is approximately 40 nm, the tip end width described above cannot sometimes be produced. In this case, the size of the step 4 in the thickness-wise direction (height of the step 4; step amount) may be increased still more and the thickness of the width-tapered region 2B may be reduced still more so that the loss of the TM polarization component can be suppressed and low polarization dependency can be implemented with the producible tip end width.

Further, where the refractive index of the second core 3 is approximately 1.48 and the step 4 of approximately 20 nm is provided in the width-fixed region 2A of the silicon waveguide core 2, namely, where the thickness of the width-tapered region 2B of the silicon waveguide core 2 is approximately 200 nm, even if the tip end width of the width-tapered region 2B is set to approximately 60 nm, the loss of the TM polarization component and increase of the polarization dependency can be suppressed as indicated by the solid line A and the broken line A in FIG. 13. In this manner, where the step 4 is small and the thickness of the width-tapered region 2B of the silicon waveguide core 2 is set not very thin, by reducing the tip end. width of the width-tapered region 2B, for example, by setting the tip end width of the width-tapered region 2B to approximately 60 nm or less, the loss of the TM polarization component, and. increase of the polarization dependency can be suppressed.

Further, where the refractive index of the second core 3 is approximately 1.48 and the step 4 of approximately 50 nm is provided in the width-fixed region 2A of the silicon waveguide core 2, namely, where the thickness of the width-tapered region 2B of the silicon waveguide core 2 is approximately 170 nm, even if the tip end width of the width-tapered region 2B is set to approximately 80 nm, the loss of the TM polarization component and increase of the polarization dependency can be suppressed as indicated by the solid line B and the broken line B in FIG. 13. In this manner, where the step 4 is great and the thickness of the width-tapered region 2B of the silicon waveguide core 2 is reduced, even if the tip end width of the width-tapered region 2B is great, if the tip end width of the width-tapered region 2B is set, for example, to approximately 80 nm or less, then the loss of the TM polarization component and increase of the polarization dependency can be suppressed.

In this manner, by setting the refractive index of the second core 3 to approximately 1.48, the condition for the tip end width of the width-tapered region 23 of the silicon waveguide core 2 can be moderated, namely, the range of the tip end width capable of implementing low polarization dependency can be increased. Therefore, increase of the polarization dependency can be easily suppressed. Further, by setting the step 4 in the width-fixed region 2A of the silicon waveguide core 2, the tip end width of the width-tapered region 2B of the silicon waveguide core 2 may not be reduced to a width substantially equal to that of a limit in production, and fabrication of the spot, size converter is facilitated and the spot size, converter can be produced with high accuracy. Particularly, since the condition for the tip end width of the width-tapered region 2B of the silicon waveguide core 2 is moderated as the size (step amount) of the step is increased and the thickness of the width-tapered region 2B of the silicon waveguide core 2 is reduced, fabrication of the spot size converter is facilitated and the spot size converter can be produced with high accuracy.

Incidentally, while the step 4 in the embodiment and the particular example described above is provided in the region, which is not covered with the second core 3, of the width-fixed, region 2A of the silicon waveguide core 2, the provision of the step 4 is not limited to this, and the step 4 may be provided in the width-fixed region 2A of the silicon waveguide core 2. For example, the step 4 may be provided in a region, which is covered, with the second core 3, of the width-fixed region 2A of the silicon waveguide core 2. In those cases, the step 4 is provided at a position other than an end face position of the side covering the width-fixed region 2A of the second core 3.

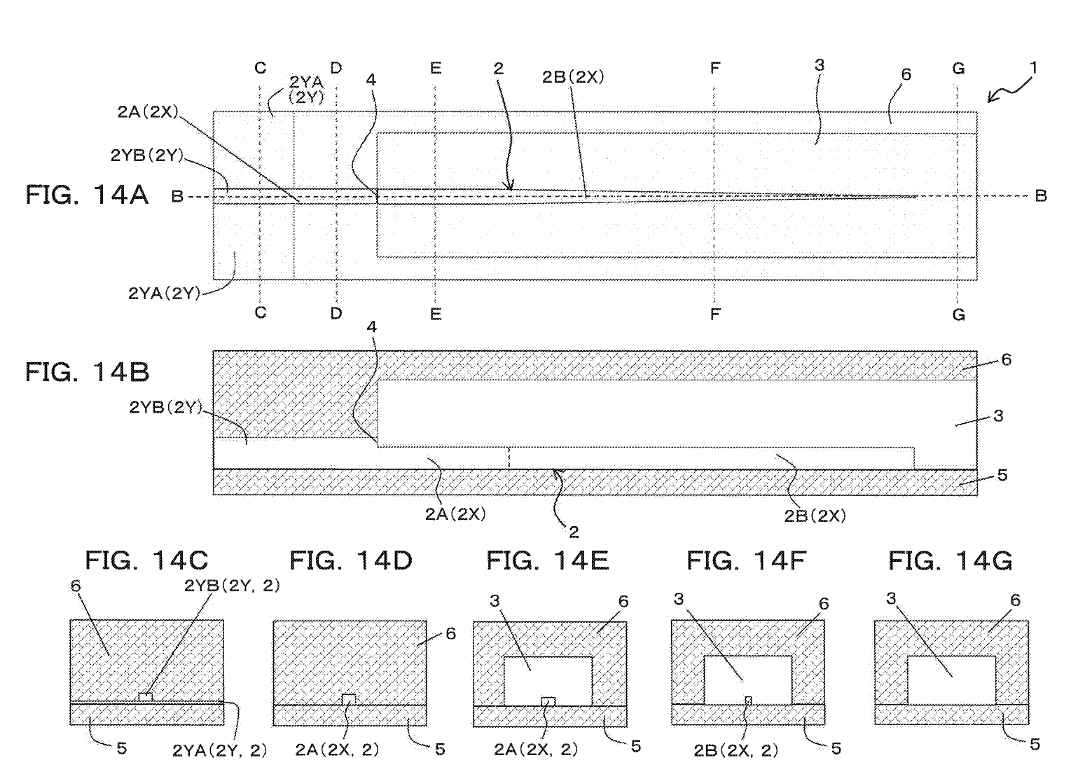

Further, for example, the step 4 may be provided, at an end face position of the side covering the width-fixed region 2A of the second core 3 as depicted in FIGS. 14A to 14G. In particular, in the particular example of the embodiment described above, the step 4 may be provided, such that the step formation location coincides with a boundary region between the second core 3 and the upper cladding layer 6. It is to be noted that the configuration just described is referred to as first modification.

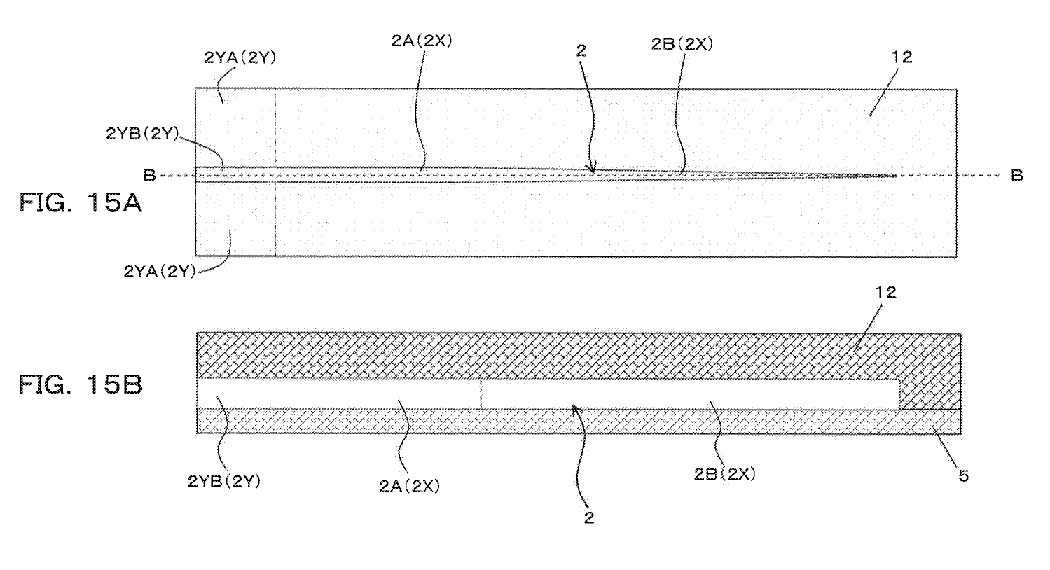

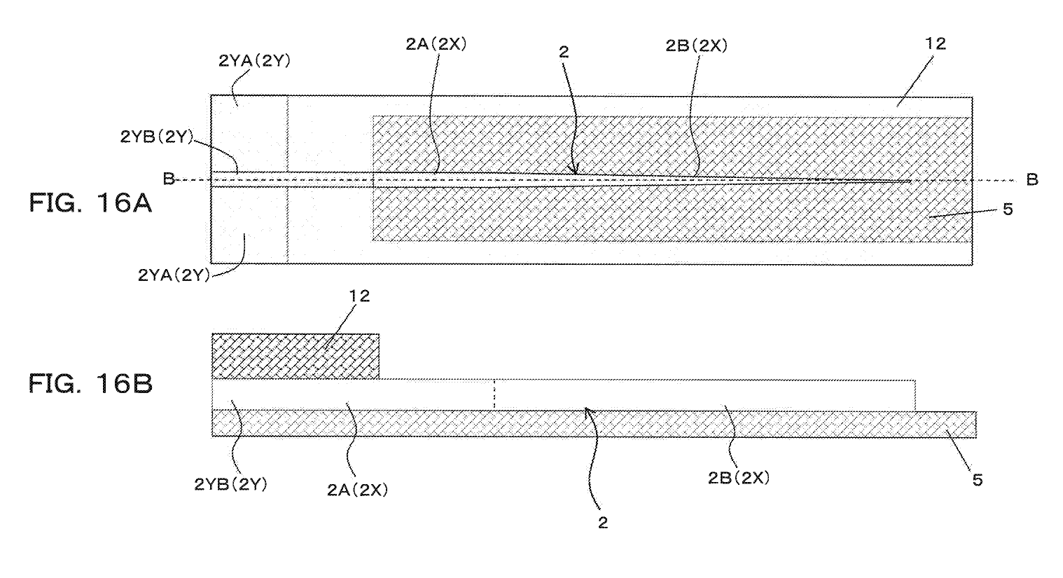

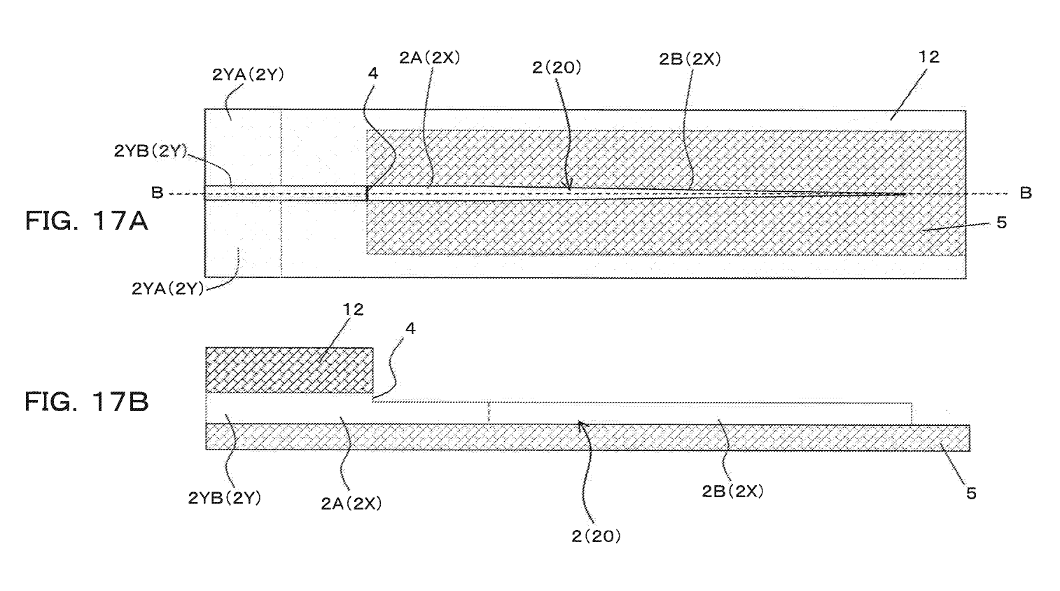

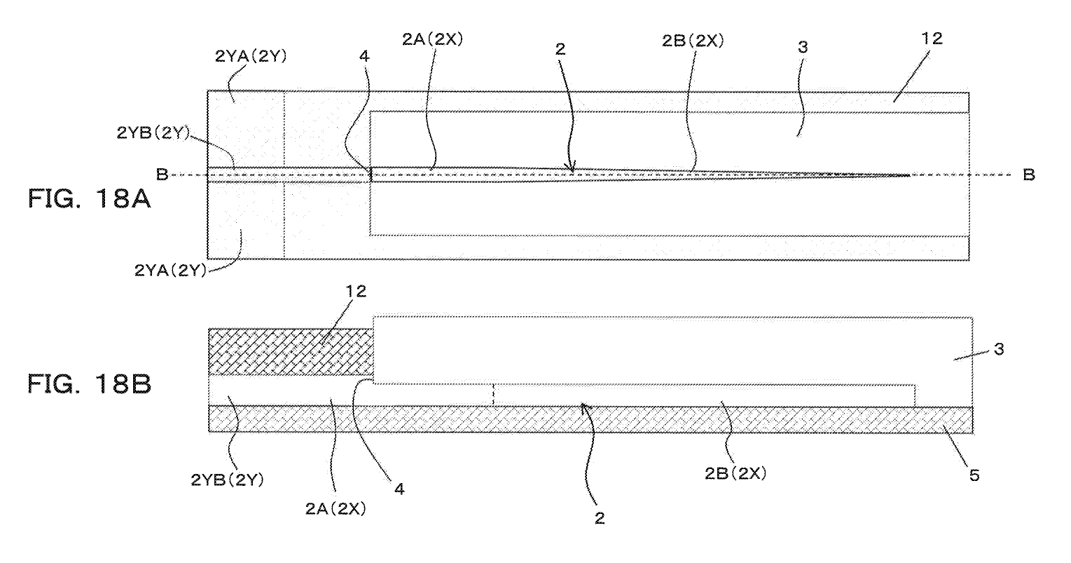

In this case, the fabrication method for the optical spot size converter 1 of the particular example of the embodiment described above may be modified in the following manner. In particular, the SOI layer 20 is etched by approximately 30 nm to provide the step 4 of approximately 30 nm in the thickness-wise direction in the width-fixed region 2A of the silicon waveguide core 2. Then, the SiO₂ film 12 (for example, approximately 1 μm thick) is deposited by a CVD method as depicted in FIGS. 15A and 15B without performing a step [refer to FIGS. 6A and 6B] at which the thickness of the width-tapered region 2B is set to approximately 190 nm, and the SiO₂ film 12 in the region in which the second core 3 is to be formed is removed by etching as depicted in FIGS. 16A and 16B. Then, the SOI layer 20 in the region in which the SiO₂ film 12 is removed is etched by approximately 50 nm as depicted in FIGS. 17A and 17B to provide the step 4 of approximately 50 nm in the thickness-wise direction in the width-fixed region 2A of the silicon waveguide core 2, and the thickness of the width-tapered region 2B is set to approximately 170 nm. Thereafter, the SiO_{X} film (for example, of a thickness of approximately 3 μm, a width of approximately 7 μm and a refractive index n=1.46) may be deposited, by a CVD method as depicted in FIGS. 18A and 18B and the unnecessary SiO_{X} film is removed by etching such that the second core 3 is formed so as to cover the width-tapered region 2B and part of the width-fixed region 2A of the silicon waveguide core 2. In this case, since the second core 3 can be produced utilizing the mask pattern formed at the preceding step, reduction of the cost can be implemented. It is to be noted that configuration of the other part is similar to that of the particular example of the embodiment described above.

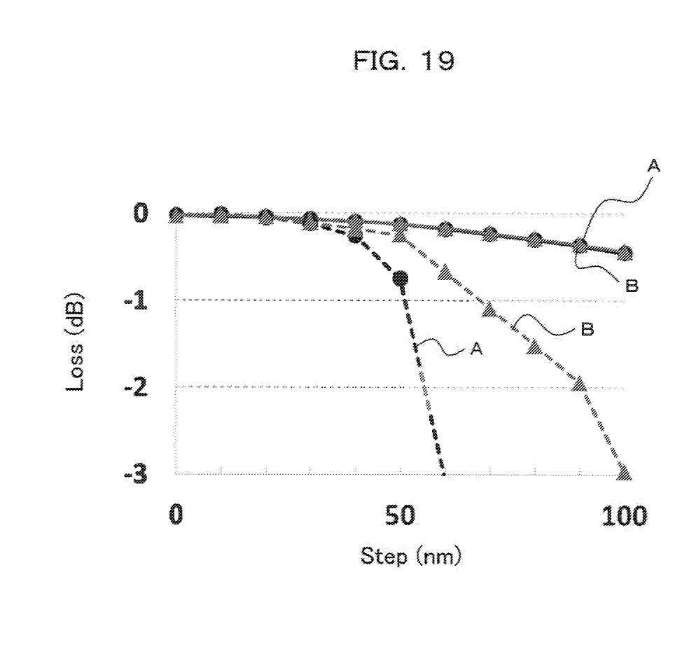

Here, FIG. 19 depicts a result of a simulation of loss with respect, to the size (step amount) of the step 4 in the thickness-wise direction provided in the width-fixed region 2A of the silicon waveguide core 2.

It is to be noted that, in FIG. 19, solid lines A and B indicate values with regard to the TE polarization component and broken lines A and B indicate values with regard to the TM polarization component. Further, in FIG. 19, a solid line A (circular symbols are plotted) and a broken line A (circular symbols are plotted) indicate values in a case in which, as in the particular example of the embodiment described above, the step 4 is provided at a position other than an end face position of the side covering the width-fixed region 2A of the second core 3 (particularly, in a case in which the step 4 is provided in the region, which is not covered with the second core 3, of the width-fixed region 2A of the silicon waveguide core 2; refer to FIGS. 1A to 1G). Further, in FIG. 19, a solid line B (triangular symbols are plotted) and a broken line B (triangular symbols are plotted) indicate values in a case (refer to FIGS. 14A to 14G) in which the step 4 is provided at an end face position of the side covering the width-fixed region 2A of the second core 3.

First, by providing the step 4 in the width-fixed region 2A of the silicon waveguide core 2 as described above, the loss of the TM polarization component can be suppressed and low polarization dependency can be implemented. Furthermore, low-loss coupling with a dispersion shift fiber or a single mode fiber can be implemented.

However, if the step 4 is provided in the width-fixed region 2A of the silicon waveguide core 2, then since scattering loss occurs at a location (stepped region) at which the step 4 is provided, the loss increases as the step amount increases as depicted in FIG. 19. Particularly, increase of the loss where the step amount is increased is remarkable with regard to the TM polarization component.

For example, where the step 4 is provided at a position other than the end face position of the side covering the width-fixed region 2A of the second core 3 as in the particular example (refer to FIGS. 1A to 1G) of the embodiment, described above, a loss difference between the TE polarization component, and the TM polarization component does not almost appear until the step amount reaches approximately 30 nm as indicated by a broken line A in FIG. 19.

Therefore, it is preferable to set the step amount to approximately 30 nm or less where the step 4 is provided at a position other than the end face position of the side covering the width-fixed region 2A of the second core 3 as in the particular example (refer to FIGS. 1A to 1G) of the embodiment described above. Consequently, decrease of the loss by scattering loss at the location at which the step 4 is provided can be suppressed. In particular, by providing the step 4, occurrence of the loss can be suppressed and occurrence of the loss difference between the TE polarization component and the TM polarization component can be suppressed.

On the other hand, where the step 4 is provided at the end face position of the side covering the width-fixed region 2A of the second core 3 (refer to FIGS. 14A to 14G), increase of the loss of the TM polarization component when the step amount is increased can be suppressed as indicated by a broken line B in FIG. 19. For example, where the step amount is approximately 40 nm or more, increase of the loss of the TM polarization component can be suppressed. For example, where the step amount is approximately 50 nm, loss suppression by approximately 0.5 dB can be implemented, and, where the step amount is approximately 60 nm, loss suppression by approximately 2.4 dB can be implemented. This is because, by providing the step 4 in the thickness-wise direction in the silicon waveguide core 2 at the position corresponding to the end face position of the second core 3, an equivalent refractive index variation of the TM polarization component is moderated and the loss of the TM polarization component can be suppressed.

It is to be noted that, even if the step amount is increased, the loss of the TE polarization component is substantially equal, as indicated by solid lines A and B in FIG. 19, between both of the case in which the step 4 is provided at a position other than the end face position of the side covering the width-fixed region 2A of the second core 3 (refer to FIGS. 1A to 1G) and the case in which the step 4 is provided at the end face position of the side covering the width-fixed region 2A of the second core 3 (refer to FIGS. 14A to 14G).

Therefore, where the step 4 is provided at. the end face position of the side covering the width-fixed region 2A of the second core 3 (refer to FIGS. 14A to 14G), it is preferable to set the step amount to approximately 50 nm or less, and it is more preferable to set the step amount to approximately 40 nm or less. Consequently, decrease of the loss by scattering loss at the location at which the step 4 is provided can be suppressed. In other words, by providing the step 4, generation of loss can be suppressed and appearance of a loss difference between the TE polarization component and the TM polarization component can be suppressed.

In this manner, by providing the step 4 at the end face position of the side covering the width-fixed region 2A of the second core 3, in comparison with an alternative case in which the step 4 is provided at a position other than the end face position of the side covering the width-fixed region 2A of the second core 3, the equivalent refractive index variation of the TM polarization component, is moderated and the loss of the TM polarization component can be suppressed. Therefore, the step amount can be increased. Further, by increasing the step amount and reducing the thickness of the width-tapered region 2B of the silicon waveguide core 2 (particularly, the thickness of the tip end portion of the width-tapered region 2B), the loss of the TM polarization component can be suppressed still further and lower polarization dependency can be implemented.

For example, the insertion loss of a dispersion shift fiber where the step 4 having a step amount of approximately 30 nm is provided at the position other than the end face position of the side covering the width-fixed region 2A of the second core 3 (refer to FIGS. 1A to 1G) is approximately 1.5 dB with regard to the TM polarization component, and is approximately 1.1 dB with regard to the TE polarization component. On the other hand, the insertion loss of a dispersion shift, fiber where the step 4 having a step amount of approximately 50 nm is provided at the end face position of the side covering the width-fixed region 2A of the second core 3 (refer to FIGS. 14A to 14G) is approximately 1.2 dB with regard to the TM polarization component and is approximately 1.3 dB with regard to the TE polarization component. In this manner, by providing the step 4 at the end face position of the side covering the width-fixed region 2A of the second core 3 and increasing the step amount and besides reducing the thickness of the width-tapered region 2B of the silicon waveguide core 2 (particularly, the thickness of the tip end portion of the width-tapered region 2B), the loss of the TM polarization component can be suppressed still further and lower polarization dependency can be implemented.

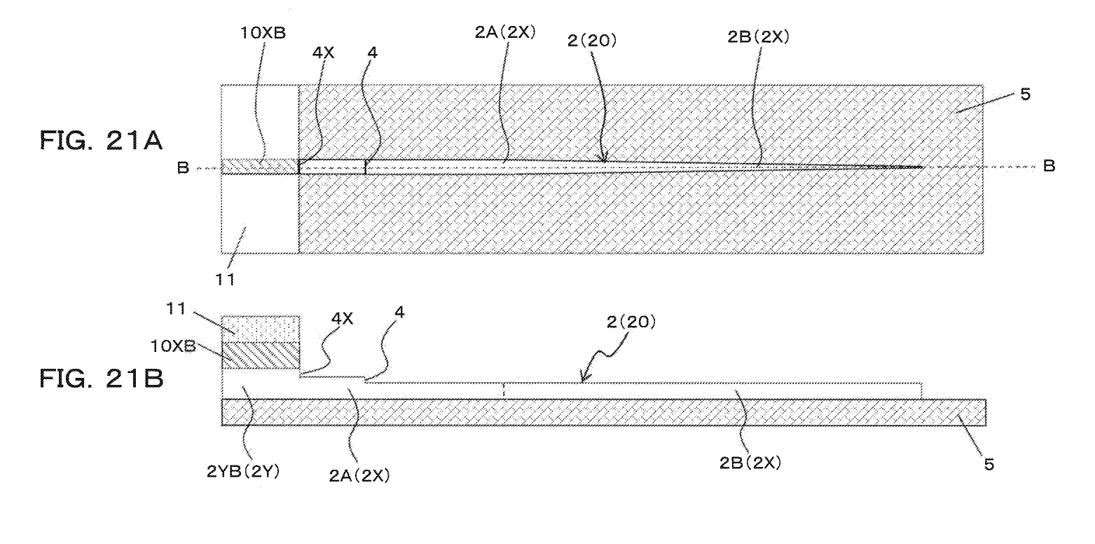

Further, the step 4 may be provided at a boundary position between the channel structure silicon waveguide core and the rib structure silicon waveguide core. In this case, the step 4 is provided in the width-fixed region 2A of the silicon waveguide core 2, namely, at a position other than the end face position of the side covering the width-fixed region 2A of the second core 3. In particular, in the particular example of the embodiment described above, the step 4 may be provided so that the step formation location coincides with the boundary region between the channel structure portion 2X and the rib structure portion 2Y of the silicon waveguide core 2. In this case, the fabrication method for the optical spot size converter in the particular example of the embodiment described above is modified in the following manner. In particular, in the fabrication method just mentioned, a region of the 301 layer 20 from an arbitrary location of the width-fixed region 2A to the tip end portion of the width-tapered region 2B of the channel structure portion 2X of the silicon waveguide core 2 is etched by approximately 30 nm using the hard mask pattern 10XA obtained by leaving the silicon waveguide core 2 in a region from the rib structure portion 2Y to a location at which the step 4 is to be formed and the resist pattern 11 covering the rib structure portion 2Y of the silicon waveguide core 2 such that, the step 4 of approximately 30 nm in the thickness-wise direction is provided in the width-fixed region 2A of the silicon waveguide core 2 and the thickness of the width-tapered region 2B is set to approximately 190 nm [refer to FIGS. 6A to 6B]. However, in the modified fabrication method just described, the SOI layer 20 from the boundary region between the rib structure portion 2Y and the channel structure portion 2X of the silicon waveguide core 2 to the tip end portion of the width-tapered region 23 is etched by approximately 30 nm using a hard mask pattern 10XB [refer to FIGS. 21A and 21B] obtained by leaving a region covering the rib portion 2YB of the rib structure portion 2Y of the silicon waveguide core 2 and the resist pattern 11 covering the rib structure portion 2Y of the silicon waveguide core 2. Consequently, the step 4 of approximately 30 nm in the thickness-wise direction is provided at the boundary location between the rib structure portion 2Y and the channel structure portion 2X of the silicon waveguide core 2 and the thickness of the width-fixed region 2A and the width-tapered region 2B of the channel structure portion 2X of the silicon waveguide core 2 is set to approximately 190 nm. It. is to be noted that the configuration of the other part is similar to that of the particular example of the embodiment described above.

Incidentally, while the step 4 is provided, in the embodiment, and particular example described above, at one location of the width-fixed region 2A of the silicon waveguide core 2, the present invention is not limited to this, the step may be provided otherwise at a plurality of locations of the width-fixed region 2A of the silicon waveguide core 2.

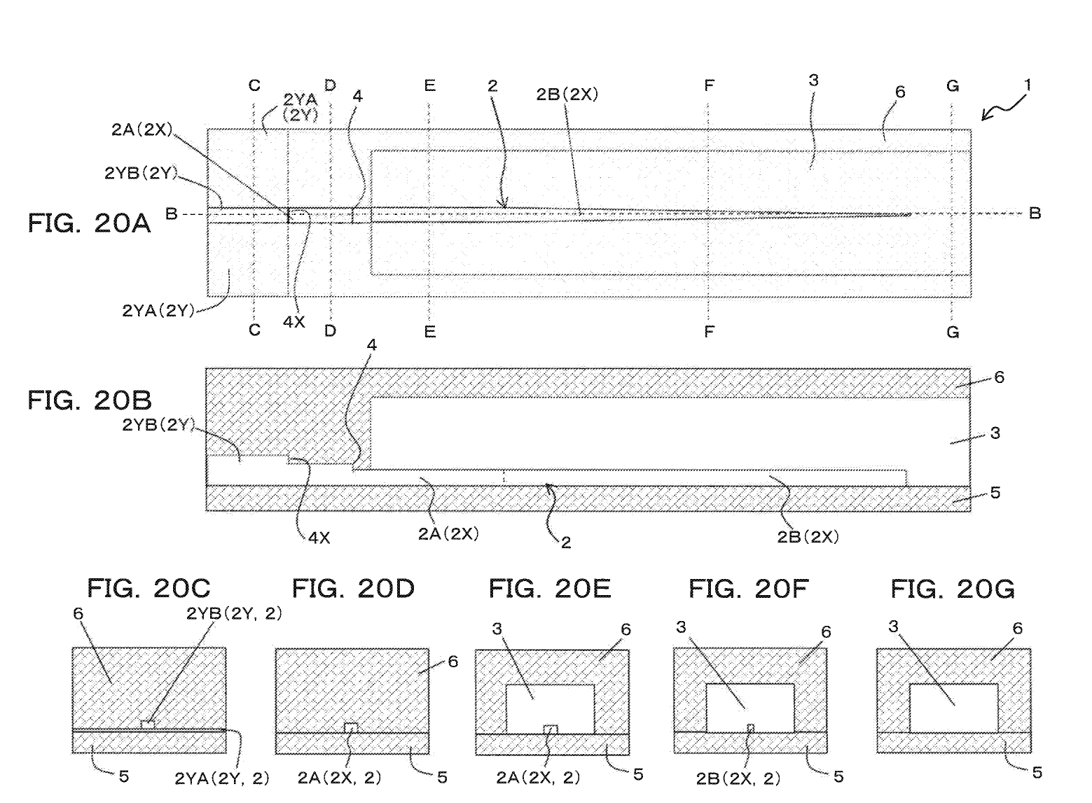

For example, as depicted in FIGS. 20A to 20G, in the configuration of the particular example of the embodiment described above, a step 4X may be additionally provided at a boundary position between the channel structure portion 2X and the rib structure portion 2Y of the silicon waveguide core 2. In this case, two steps including the step 4 (first step) provided at a position other than an end face position of the side covering the width-fixed region 2A of the second core 3 and the step 4X (second step) provided at the boundary position between the channel structure portion 2X (channel structure silicon waveguide core) and the rib structure portion 2Y (rib structure silicon waveguide core) of the silicon waveguide core 2 are provided. It is to be noted that this is referred to as second modification.

For example, the step 4X of, for example, approximately 20 nm may be provided at the boundary position between the channel structure portion 2X and the rib structure portion 2Y of the silicon waveguide core 2 and the step 4 of approximately 30 nm may be provided at one location of the width-fixed region 2A of the channel structure portion 2X of the silicon waveguide core 2. Consequently, the steps having approximately totaling 50 nm are provided such that the thickness of the width-tapered region 2B of the silicon waveguide core 2 is approximately 170 nm. Therefore, an effect substantially similar to that of the case in which the step 4 having a step amount of approximately 50 nm is provided at the end face position of the side covering the width-fixed region 2A of the second core 3 (refer to FIGS. 14A to 14G) is achieved. Further, the thickness of the width-tapered region 2B of the silicon waveguide core 2 is reduced still further with respect to the configuration of the particular example (refer to FIGS. 1A to 1G) of the embodiment described above while the step amount of the steps is decreased to suppress increase of the loss caused by provision of the step such that the loss of the TM polarization component can be suppressed and lower polarization dependency can be implemented. In this case, the fabrication method for the optical spot size converter in the particular example of the embodiment described above is modified in the following manner in regard to the steps described below. In particular, in the fabrication method, for the optical spot size converter of the particular example of the embodiment described above, a region of the SOI layer 20 from an arbitrary location of the width-fixed region 2A to the tip end portion of the width-tapered region 23 of the channel structure portion 2X of the silicon waveguide core 2 is etched by approximately 30 nm using the hard mask pattern 10XA obtained by leaving a region of the silicon waveguide core 2 from the rib structure portion 2Y to a location at which the step 4 is to be formed and the resist pattern 11 covering the rib structure portion 2Y of the silicon waveguide core 2. Consequently, the step 4 of approximately 30 nm in the thickness-wise direction is provided in the width-fixed region 2A of the silicon waveguide core 2 and the thickness of the width-tapered region 2B is set to approximately 190 nm [refer to FIGS. 6A and 6B]. However, in the modified fabrication method, described above, the region of the SOI layer 20 from an arbitrary location of the width-fixed region 2A to the tip end portion of the width- tapered region 2B of the channel structure portion 2X of the silicon waveguide core 2 is etched by approximately 30 nm using the hard mask pattern 10XA obtained by leaving the region of the silicon waveguide core 2 from the rib structure portion 2Y to a location at which the step 4 is to be formed and the resist pattern II covering the rib structure portion 2Y of the silicon waveguide core 2 [refer to FIGS. 6A and 6B]. Then, as depicted in FIGS. 21A and 21B, the region of the SOI layer 20 from the boundary location between the rib structure portion 2Y and the channel structure portion 2X of the silicon waveguide core 2 to the tip end portion, of the width-tapered region 2B is etched by approximately 20 nm using a hard mask pat tern 10XB obtained by leaving a portion, at which the rib portion 2YB is covered, of the rib structure portion 2Y of the silicon waveguide core 2 and the resist pattern 11 covering the rib structure portion 2Y of the silicon waveguide core 2. Consequently, the step 4 of approximately 30 nm in the thickness-wise direction is provided in the width-fixed region 2A of the silicon waveguide core 2 and the step 4X of approximately 20 nm in the thickness-wise direction is provided at the boundary location between the rib structure portion 2Y and the channel structure portion 2X of the silicon waveguide core 2, and the thickness of the width-tapered region 2B is set to approximately 170 nm. In this manner, the second core 3 can be produced only if the etching step is added to the fabrication method for the spot size converter of the particular example of the embodiment described above, and therefore, a step formation location can be additionally provided easily and low-polarization dependency can be implemented easily.

Further, for example, where the step 4 is provided at the end face position of the side covering the width-fixed region 2A of the second core 3 described above (refer to FIGS. 14A to 14G), a step may be additionally provided at the boundary position between the channel structure portion 2X and the rib structure portion 2Y of the silicon waveguide core 2. In this case, two steps including the step (third step) provided at the end face position of the side covering the width-fixed region 2A of the silicon waveguide core 2 and the step (fourth step) provided at the boundary position between the channel structure portion 2X (channel structure silicon waveguide core) and the rib structure portion 2Y (rib structure silicon waveguide core) of the silicon waveguide core 2 are provided. In this case, since the steps can be produced utilizing the mask pattern formed at the preceding step, reduction of the cost can be implemented.

By providing a step at a plurality of locations in this manner, the thickness of the width-tapered region 2B of the silicon waveguide core 2 can be reduced while the step amount of each step is decreased. Further, since the condition for the tip end width of the width-tapered region 2B of the silicon waveguide core 2 is moderated as the thickness of the width-tapered region 2B of the silicon waveguide core 2 is reduced, fabrication of the second core is facilitated and the silicon waveguide core 2 can be produced with high accuracy.

Incidentally, while reduction of the thickness of the 301 layer 20 for forming the steps 4 and 4X in the embodiment and modifications described above is performed after the width-fixed region 2A and the width-tapered region 2B of the silicon waveguide core 2 are formed, the reduction of the thickness is not limited to this. For example, the width-fixed region and the width-tapered region of the silicon waveguide core may be formed after the SOI layer is etched entirely to reduce the thickness of the SOI layer to form the steps. Further, for example, the width-fixed region and the width-tapered region of the silicon waveguide core may foe formed after the SOI layer is etched entirely to reduce the thickness of the SOI layer to form a first, step, and then reduction of the thickness of the SOI layer for forming a second step may be performed.

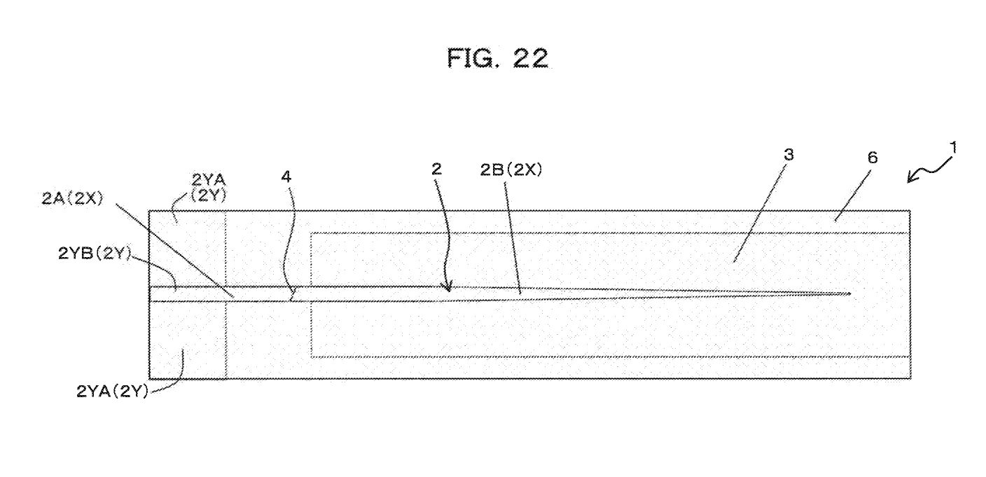

Further, in the embodiment and modifications described above, in order to suppress reflection and so forth at the locations at which the steps 4 and 4X are provided, also it is preferable to provide the steps 4 and 4X obliquely to a direction orthogonal to the extending direction of the width-fixed region 2A of the silicon waveguide core 2. For example, in the embodiment and modifications described above, also it is preferable to provide the step 4 obliquely to a direction orthogonal to the extending direction of the width-fixed region 2A of the silicon waveguide core 2 as depicted in FIG. 22. It is to be noted that the configuration just described is referred to as third modification. Further, in order to suppress reflection and so forth at the end face position of the side covering the width-fixed region 2A of the second core 3, also it is preferable to provide the end face of the second core 3 obliquely to a direction orthogonal to the extending direction of the width-fixed region 2A of the silicon waveguide core 2.

Further, while, in the embodiment and modifications described above, SiO_{X} is used as the material of the second core 3, the material of the second core 3 is not limited to this. For example, as the material of the second core 3, a different silicon compound such as SiON (silicon oxynitride) or polymer may be used. In particular, the second core 3 maybe configured as a silicon compound waveguide core for which a silicon compound of SiO_{X}, SiON or the like is used or as a polymer waveguide core for which polymer is used. However, for example, where SiON is used as the material for the second core 3, since absorption loss by N—H groups occurs, it is preferable to reduce the length of the second core 3 as far as possible.

Further, a dispersion shift, fiber or a single mode fiber can be coupled with the end face at the second core side of the spot size converter of any of the embodiment and modifications described above to configure the optical apparatus. In this case, the optical apparatus includes the spot size converter 1 of any of the embodiment and modifications described above and a dispersion shift fiber or a single mode fiber coupled with the end face at the second core side of the spot, size converter 1. For example, the optical apparatus can be configured by jointing the dispersion shift fiber or the single mode fiber, for example, by adhesive or the like with the end face at the second core side of the spot size converter 1 of any of the embodiment and modifications described above. As such an optical apparatus as just described, for example, an optical transmitter, an optical receiver, an optical transmitter-receiver or a light source is available.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or snore embodiments of the present inventions have been described in detail, it should be understood that the various changes, substitutions, and alterations could be made hereto without departing from the spirit and scope of the invention.

What is claimed is:

1. A spot size converter, comprising:
a first silicon waveguide core that includes a width-fixed region having a fixed width and a width-tapered region continuing to the width-fixed region and having a width reducing toward a terminal portion; and
a second waveguide core continuing to the first silicon waveguide core and covering at least the width-tapered region; wherein
the first silicon waveguide core has a thickness-wise step in the width-fixed region.

2. The spot size converter according to claim 1, wherein the second waveguide core partially covers the width-fixed region; and
the step is provided at an end face position of a side covering the width-fixed region of the second waveguide core.

3. The spot size converter according to claim 1, wherein the first silicon waveguide core is a channel structure silicon waveguide core;
the spot size converter further comprising a rib structure silicon waveguide core that continues to a side opposite to the width-tapered region across the width-fixed region;
the step being provided at a boundary position between the channel structure silicon waveguide core and the rib structure silicon waveguide core.

4. The spot size converter according to claim 1, wherein the second waveguide core partially covets the width-fixed region; and
the first silicon waveguide core is a channel, structure silicon waveguide core;
the spot size converter further comprising a rib structure silicon waveguide core that continues to the opposite side to the width-tapered region across the width-fixed region;
the step including a first step provided at a position other than an end face position of a side covering the width-fixed region of the second waveguide core and a second step provided at a boundary position between the channel structure silicon waveguide core end the rip structure silicon waveguide core.

5. The spot size converter according to claim 1, wherein the second waveguide partially covers the width-fixed portion; and
the first silicon waveguide core is a channel structure silicon waveguide core;
the spot size converter further comprising a rib structure silicon waveguide core that continues to a side opposite to the width-tapered region across the width-fixed region;
the step including a third step provided at an end face position of a side covering the width-fixed region of the second waveguide core and a fourth step provided at a boundary position between the channel structure silicon waveguide core and the rib structure silicon waveguide core.

6. The spot size converter according to claim 1, wherein the stop is provided at a plurality of locations of the width-fixed region.

7. The spot size converter according to claim 1, wherein the step is provided obliquely to a direction orthogonal to an extending direction of the width-fixed region.

8. An optical apparatus, comprising:
the spot size converter including a first silicon waveguide core that includes a width-fixed region having a fixed width and a width-tapered region continuing to the width-fixed region and having a width reducing toward a terminal portion, and a second waveguide core continuing to the first silicon waveguide core and covering at least the width-tapered region, the first silicon waveguide core having a thickness-wise step in the width-fixed region; and
a dispersion shift fiber or a single-mode fiber coupled to an end face on a side of the second waveguide core of the spot size converter.

9. The optical apparatus according to claim 8, wherein the second waveguide core partially covers the width-fixed region; and
the step is provided at an end face position of a side covering the width-fixed region of the second waveguide core.

10. The optical apparatus according to claim 8, wherein the first silicon waveguide core is a channel structure silicon waveguide core;
the spot size converter further comprising a rib structure silicon waveguide core that continues to a side opposite to the width-tapered region across the width-fixed region;
the step being provided at a boundary position between the channel structure silicon waveguide core and the rib structure silicon waveguide core.

11. The optical apparatus according to claim 8, wherein the second waveguide core partially covers the width-fixed region; and
the first silicon waveguide core is a channel structure silicon waveguide core;
the spot size converter further comprising a rib structure silicon waveguide core that continues to the opposite side to the width-tapered region across the width-fixed region;
the step including a first step provided at a position other than an end face position of a side covering the width-fixed region of the second waveguide core and a second step provided at a boundary position between the channel structure silicon waveguide core and the rib structure silicon waveguide core.

12. The optical apparatus according to claim 8, wherein the second waveguide core partially covers the width-fixed portion; and
the first silicon waveguide core is a channel structure silicon waveguide core;
the spot, size converter further comprising a rib structure silicon waveguide core that continues to a side opposite to the width-tapered region across the width-fixed region;
the step including a third step provided at an end face position of a side covering the width-fixed region of the second waveguide core and a fourth step provided at a boundary position between the channel structure silicon waveguide core and the rib structure silicon waveguide core.

13. The optical apparatus according to claim 8, wherein the step is provided at a plurality of locations of the width-fixed region.

14. The optical apparatus according to claim 8, wherein the step is provided obliquely to a direction orthogonal to an extending direction of the width-fixed region.
